(19) United States
(12) Patent Application Publication
(10) Pub. No.: US 2026/0262895 A1
(43) Pub. Date: Sep. 10, 2026

(54) Automated Cleaning Apparatus and Method for Use on Vertical Surfaces

(71) Applicant: P16 Holdings, LLC, Amarillo, TX (US)

(72) Inventors: Todd Perry Bentley, Amarillo, TX (US); Brian Patrick Schoolcraft, Cedar Park, TX (US); William John Elliott, Leander, TX (US); Brian Sweeet, Liberty Hill, TX (US); Robert Logan Butler, Liberty Hill, TX (US); Christian De Jesus Ruiz, Liberty Hill, TX (US)

(73) Assignee: P16 Holdings, LLC, Amarillo, TX (US)

(21) Appl. No.: 19/489,157

(22) PCT Filed: Aug. 2, 2024
(86) PCT No.: PCT/US2024/040767

§ 371 Date: Dec. 1, 2025

Related U.S. Application Data
(60) Provisional application No. 63/470,738, filed on Jun. 2, 2023.

(51) Int. Cl. A47L 11/38; B08B 1/16; B08B 1/30; B08B 1/40; E04G 23/00

(52) U.S. Cl. CPC A47L 11/38; B08B 1/165; B08B 1/30; B08B 1/40; E04G 23/004

(57) ABSTRACT

A self-contained, automated cleaning apparatus for use on substantially vertical surfaces is disclosed. The cleaning apparatus is modular in nature, and includes a rotating platform assembly, a plurality of wheel assemblies, a scrubber assembly, a wiper assembly, a tank assembly, a removable filter assembly, a shroud assembly, and a scraper assembly. The cleaning apparatus is a safe way to clean substantially vertical surfaces, is environmentally friendly, easily transported, and is cost-effective.

This application claims priority to Provisional Patent Application No. 63/470,738 filed on Jun. 2, 2023. This application is incorporated by reference in its entirety as if fully set forth herein.

### FIELD

The current invention is an automated cleaning apparatus and method for use on substantially vertical surfaces.

### BACKGROUND

As technology is changing and renewable energy is becoming more attractive, the generation of wind energy is a growing commodity. To produce this wind energy, large wind farms consisting of high-height wind turbines are being built in multiple locations. These wind farms can include hundreds of wind turbines that require continuous maintenance. One of the most common types of maintenance required is the cleaning of both the interior and exterior of the wind turbine tower support structures. Because of the size, shape, and height of the wind turbines, this becomes a dangerous and expensive job requiring trained individuals, specialized safety equipment, and hundreds of hours of manual manpower.

There are several methods that are currently in place to clean the tower support structures of wind turbines. The first method employs a crew (typically 2-3 individuals) that climbs the wind turbines with specialized rope safety equipment (rigging) to manually clean the tower support structures with rags. These individuals descend off the wind turbines with ropes and hand clean the tower support structures. Indeed, these individuals are required to carry their cleaning materials with them and are limited in the amount of space that can be cleaned at a time. Each time the individual completes the cleaning of the area where he or she is rigged on the tower support structure, the individual must reorient his or her position on the tower support structure and continue the process. This method typically takes 20-40 hours to properly clean a tower depending on its size and condition. While this is currently the only method of cleaning where the cleaning solution and waste material are fully contained, the manual method of cleaning the tower support structures creates an opportunity for personal injury to the crew members, takes numerous hours of manual labor, and is expensive; thus, making this method undesirable. As can be understood, this method is cumbersome, time consuming, and dangerous which results in a high cost. However, currently, this is the most responsible and environmentally friendly solution.

The second method of cleaning the tower support structures is by using pressure washing techniques. This can be done by using a suspended platform, a boom truck, rope access, or drone cleaning. All of these methods use pressure washing that is in itself problematic when cleaning tower support structures. In particular, pressure washing uses large amounts of water, is not self-contained, spreads atomized particles of hazardous material into the air and onto the ground and poses significant safety problems for the crews cleaning the tower support structures. It becomes problematic to get 1900-3800 liters (500-1000 gallons) of water to the wind turbine to use with the pressure washers. Large trucks carrying tanks of water are used to haul the water out to the site, making the pressure washing technique impractical and unscalable. Moreover, pressure washing inside tower support structures is problematic due to the presence of electronics and the challenge of getting the water out of the base of the tower support structure.

The suspended platform technique requires a crew to haul a trailer with the platform and its rigging to the wind turbine site. Once the platform is unloaded at the site, there is a complex rigging scenario to properly secure the platform to the wind turbine. The platform is rigged to the nacelle portion of the wind turbine and must include a backup and rescue system. This is quite cumbersome and costly and presents yet another non-scalable situation.

Moreover, when using a boom truck to pressure wash a tower support structure, there are several problems that can occur. First, a boom truck requires a solid, flat surface that can handle the significant load of the truck plus the added load being hoisted at an angle to access the tower support structure. Secondly, these trucks are very expensive and create an untenable financial situation. Finally, boom trucks cannot be used to clean the insides of the tower support structures when needed. This requires an entirely second type of setup and rigging to complete the job.

Finally, the rope access method of cleaning the tower support structures presents all of the problems set forth with pressure washing, in addition to specific safety issues. While pressure washing a tower support structure using rope access, the crew must be very careful where the pressure wash spray is being directed. If a crew member accidentally sprays in the direction of a fellow crew member, the pressure wash spray could cut the ropes that are under tension or could spray a fellow crew member. Because of the high pressure of the spray, the water coming out of the sprayer can cause severe physical injury as well as a fall hazard.

Because the hand washing method is the most responsible and environmentally safe, it has become necessary to streamline this process to make it safer, faster, and less expensive to complete. Thus, the currently disclosed automated device and method of cleaning tower support structures has been created to achieve a clean tower support structure in a more efficient, safer, environmentally friendly, and cost-effective way than the traditional manual method. The device and method of the current invention improve the manual method and prior art by providing safer working conditions for the cleaning crew, more effective cleaning, less waste, and improved time and cost efficiency.

Considering the various cleaning devices on the market and those found in various patents and patent publications, none of these devices provide all the elements that result in the safety, effectiveness, environmentally friendly, improved time and cost efficiency, and performance found in the present invention. One of the patents relevant to this invention include U.S. Pat. No. 11,426,770 issued to Bentley et al. which is incorporated by reference in its entirety as if fully set forth herein.

### SUMMARY

The present invention provides apparatus, systems, and methods in which an automated cleaning machine for use on vertical surfaces includes a rotating platform assembly, a plurality of wheel assemblies, a scrubber assembly, a wiper assembly, and a tank assembly.

The rotating platform assembly comprises a rotating platform that includes a rotating platform first end, a rotating platform second end, a rotating platform first side, a rotating platform second side, and a rotating platform center. The rotating platform assembly also comprises a bearing having a bearing center that is coupled to the rotating platform such that the bearing center aligns with the center of the rotating platform, and wherein the bearing allows the rotating platform to rotate. The rotating platform assembly also includes a first rocker arm (also known as a bogie arm) and a second rocker arm, where each have a first wheel assembly connection point and a second wheel assembly connection point, respectively. Finally, in the rotating platform assembly, the first rocker arm is moveably coupled to the rotating platform first side, and the second rocker arm is moveably coupled to the rotating platform second side.

With respect to the plurality of wheel assemblies, each wheel assembly comprises an articulating wheel base having an articulating wheel base apparatus side, an articulating wheel base surface side, an articulating wheel base first side, and an articulating base second side. Each wheel assembly also includes a plurality of non-magnetic wheels wherein the plurality of wheels are coupled to the articulating wheel base first side and the articulating wheel base second side. Moreover, each wheel assembly comprises at least one magnet wherein the at least one magnet couples to the articulating wheel base in order to allow the cleaning apparatus to be used on the substantially vertical surface.

Regarding the scrubber assembly, the scrubber assembly comprises a scrubber backing plate having a scrubber backing plate front side and a scrubber backing plate back side. The scrubber assembly also includes a bracket with at least one mounting tab wherein the bracket is removably coupled to the scrubber backing plate back side and includes a bracket top side, a bracket bottom side, a bracket scrubber backing plate side, and a bracket rotating platform side. There is also fluid distribution tubing comprising at least one fluid dispensing device and coupled to the bracket. The scrubber assembly additionally includes at least one scrubber pad removably coupled to the scrubber backing plate front side.

Moreover, the scrubber assembly also includes a motor assembly, wherein the motor assembly comprises a motor, a shaft, and an eccentric plate mount, wherein the shaft is coupled to the eccentric plate mount. The motor assembly is coupled to a motor gimbal, and the motor gimbal is coupled to the bracket and a motor face plate. The motor face plate comprises a hole, wherein the shaft extends in the direction of the scrubber backing plate through the hole. The eccentric plate mount contacts the scrubber backing plate backside, and the motor face plate is coupled to the scrubber backing plate with at least one vibration isolator. Finally, the scrubber assembly fits within a distance between the wheel assemblies of each of the first and second rocker arms.

Finally, the cleaning apparatus comprises a wiper assembly comprising at least one wiper element, and a tank assembly comprising at least one tank that is coupled to the fluid distribution tubing. When used in conjunction, all of these elements form an automated cleaning apparatus that is used on substantially vertical surfaces.

It is an object of the present invention to provide an automated cleaning apparatus for use on high-height, substantially vertical surfaces.

It is a further object of the present invention to provide an automated cleaning apparatus for use on high-height substantially vertical surfaces that reduces the amount of water used to clean the surface.

It is a further object of the present invention to provide an automated cleaning apparatus for use on high-height substantially vertical surfaces that is a self-contained system.

It is a further object of the present invention to provide an automated cleaning apparatus for use on high-height substantially vertical surfaces that recycles dirty water into clean water.

It is still a further object of the present invention to provide an automated cleaning apparatus that includes modular pieces for ease of maintenance and use.

It is still a further object of the present invention to provide an automated cleaning apparatus for use on high-height substantially vertical surfaces that is faster than current methods.

It is still a further object of the present invention to provide an automated cleaning apparatus for use on high-height substantially vertical surfaces that is more cost effective than current methods.

The method, overall operation, and technical characteristics of the present invention will become apparent with the detailed description of preferred embodiments and the illustration of the related drawings herein.

### BRIEF DESCRIPTION OF THE DRAWINGS

FIG. 1A is a side view of the preferred embodiment of the cleaning apparatus.

FIG. 1B is a side view of the preferred embodiment of the cleaning apparatus with an external recycling system.

FIG. 2A is a back view of the preferred embodiment of the cleaning apparatus.

FIG. 2B is a back view of the preferred embodiment of the cleaning apparatus with an external recycling system.

FIG. 2C is a back view of the preferred embodiment of the portion above the tank assembly of the cleaning apparatus.

FIG. 2D is a back view of the preferred embodiment of the upper portion of the cleaning apparatus showing a cross section view of the tank assembly with an external recycling system.

FIG. 2E is an exploded view of the preferred embodiment of the external recycling system.

FIG. 3A is a front view of a preferred embodiment of the cleaning apparatus.

FIG. 3B is a front view of a preferred embodiment of the cleaning apparatus with the scrubber pad removed.

FIG. 4 is a back perspective view of a preferred embodiment of the scrubber assembly.

FIG. 5 is a front perspective view of a preferred embodiment of the scrubber assembly.

FIG. 6A is a top perspective view of a preferred embodiment of the wiper assembly.

FIG. 6B is a top perspective view of a second preferred embodiment of the wiper assembly.

FIG. 6C is a top perspective view of a third preferred embodiment of the wiper assembly.

FIG. 6D is a top perspective view of a fourth preferred embodiment of the wiper assembly.

FIG. 6E is a top perspective view of a fifth preferred embodiment of the wiper assembly.

FIG. 6F is a top perspective view of a sixth preferred embodiment of the wiper assembly with.

FIG. 7A is a front perspective view of a preferred embodiment of the rotating platform assembly.

FIG. 7B is a side view of a preferred embodiment of the first side rotating platform assembly.

FIG. 7C is a top view of a preferred embodiment of the rotating platform assembly.

FIG. 8A is a front view of a first preferred embodiment of the cleaning apparatus above the tank assembly with a leading and trailing wiper on the wiper assembly.

FIG. 8B is a front view of a second preferred embodiment of the cleaning apparatus above the tank assembly with a trailing wiper on the wiper assembly.

FIG. 8C is a front view of a third preferred embodiment of the cleaning apparatus above the tank assembly with a trailing wiper with leading intermittent wipers on the wiper assembly.

FIG. 8D is a front view of a fourth preferred embodiment of the cleaning apparatus above the tank assembly.

FIG. 8E is a front view of a fifth preferred embodiment of the cleaning apparatus above the tank assembly.

FIG. 8F is a front view of a sixth preferred embodiment of the cleaning apparatus above the tank assembly.

FIG. 9A is a top view of a preferred embodiment of the cleaning apparatus.

FIG. 9B is a bottom view of a preferred embodiment of the cleaning apparatus.

FIG. 10A is a cross section view of a preferred embodiment of the tank assembly with one tank.

FIG. 10B is a cross section view of a preferred embodiment of the top portion of the tank assembly.

FIG. 11 is a force body diagram of a preferred embodiment of the cleaning apparatus.

FIG. 12 is a top perspective view of a preferred embodiment of the cleaning apparatus with a shroud and scraper assembly.

FIG. 13 is a cross section side view of a preferred embodiment of the cleaning apparatus with a scraper and shroud assembly and an external camera assembly.

FIG. 14 is a cross section view of a preferred embodiment of the cleaning apparatus with a spray shroud assembly.

FIG. 15A is a front view of a preferred embodiment of the scraper assembly.

FIG. 15B is a back view of a preferred embodiment of the scraper assembly.

FIG. 15C is a front view of a preferred embodiment of the scraper assembly with a gutter.

FIG. 15D is a front view of the second preferred embodiment of the scraper assembly with the gutter.

FIG. 15E is a side view of a preferred embodiment of the scraper assembly with the lifting mechanism.

FIG. 16A is a view of a wind turbine tower.

FIG. 16B is a view of a wind turbine tower with the cleaning apparatus rigged to the nacelle.

FIG. 17 is perspective view of a preferred embodiment of the coupling of the scrubber assembly and rotating platform assembly.

FIG. 18 is a perspective view of a preferred embodiment of the coupling of the wiper assembly and the rotating platform assembly.

FIG. 19 is a perspective view of a preferred embodiment of the coupling of the shroud assembly to the rotating platform assembly and scrubber assembly.

### DETAILED DESCRIPTION

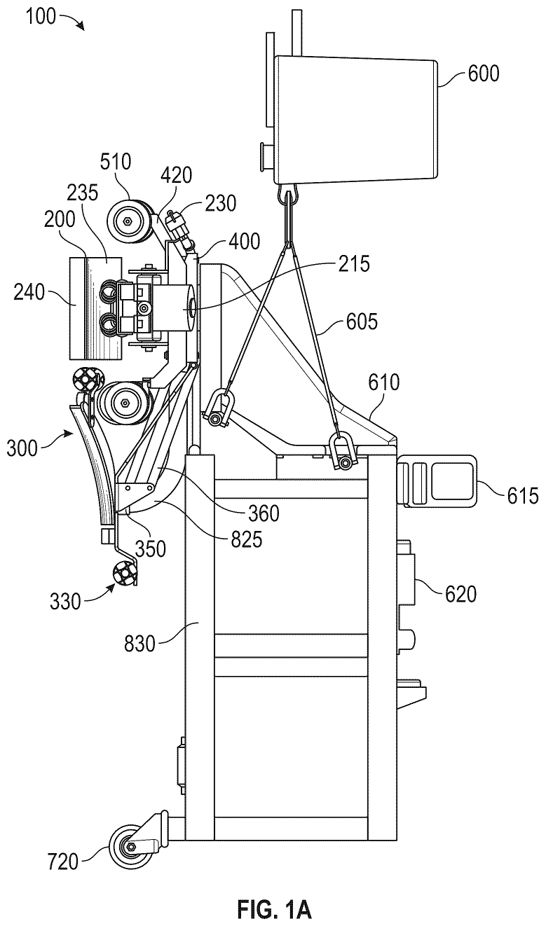

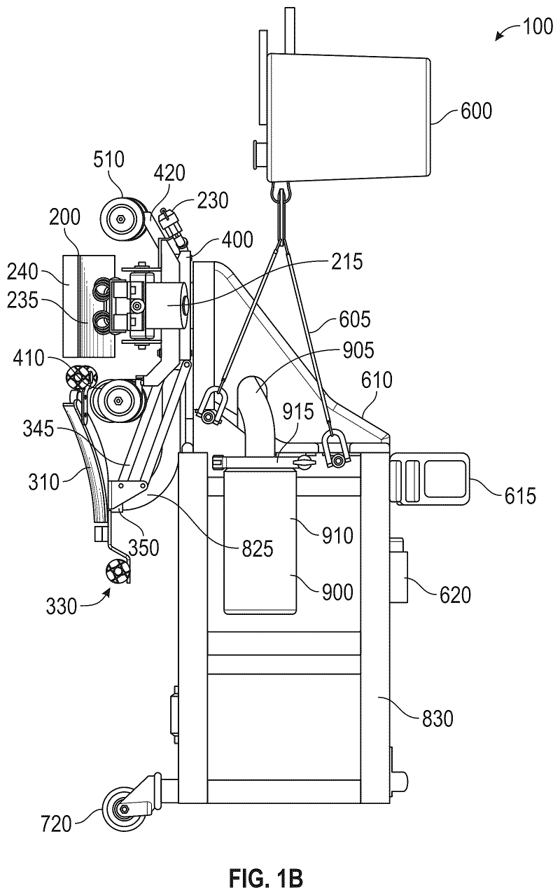

The present invention relates to an automated, self-contained cleaning apparatus 100 that allows the user to safely and efficiently clean high-height, substantially vertical surfaces. As seen in FIGS. 1A, 1B, 2A, 2B, 13, and 14 in one preferred embodiment, the automated, self-contained cleaning apparatus 100 comprises a rotating platform assembly 400, a scrubber assembly 200, a wiper assembly 300, a wheel assembly 500, and a tank assembly 700. When these elements are configured in a particular way, a safe, efficient, and environmentally friendly automated, self-contained cleaning machine 100 for use on high-height, substantially vertical structures is created. It is preferred that these elements are modular in that they can be easily attached and detached from each other in order to make repairs and configuration changes easy and efficient. The modular design of the device also allows for easy transport and set up at the work site.

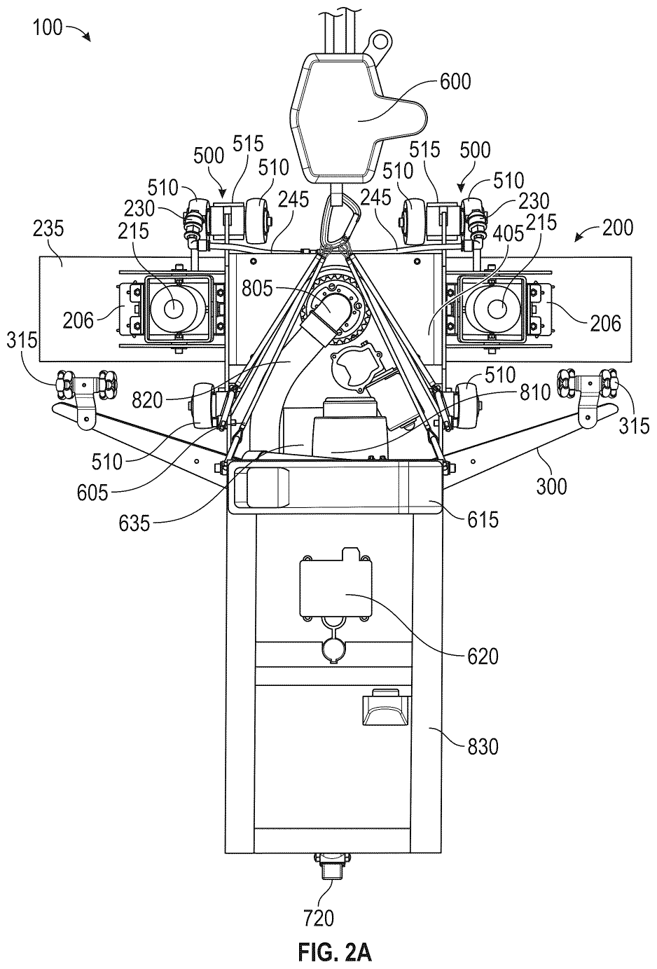

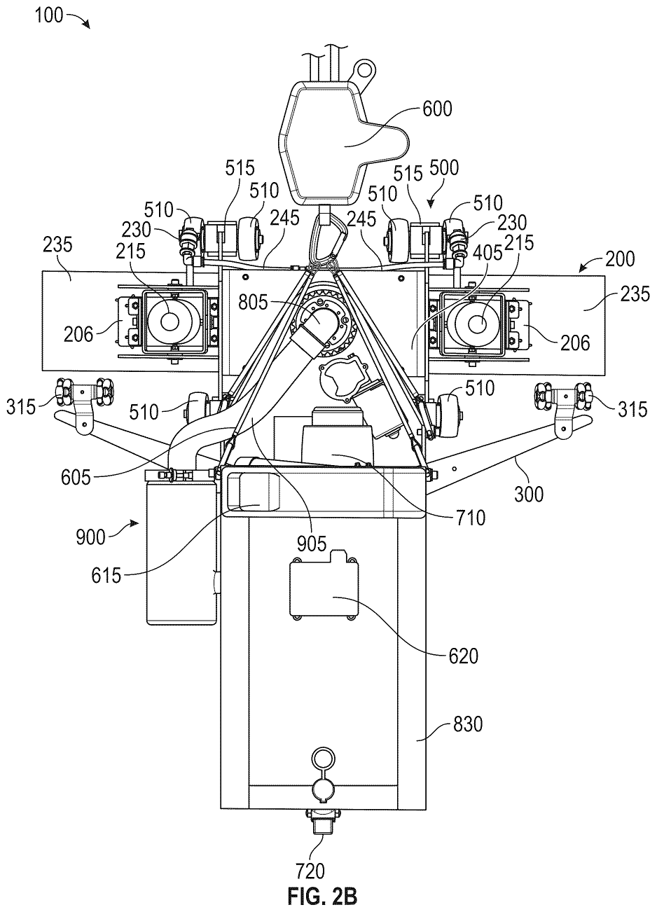

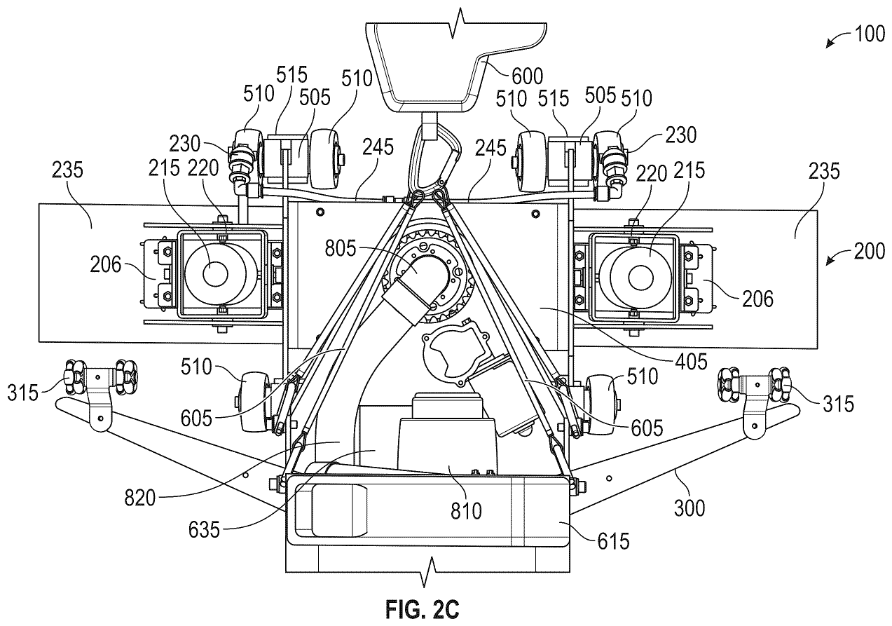

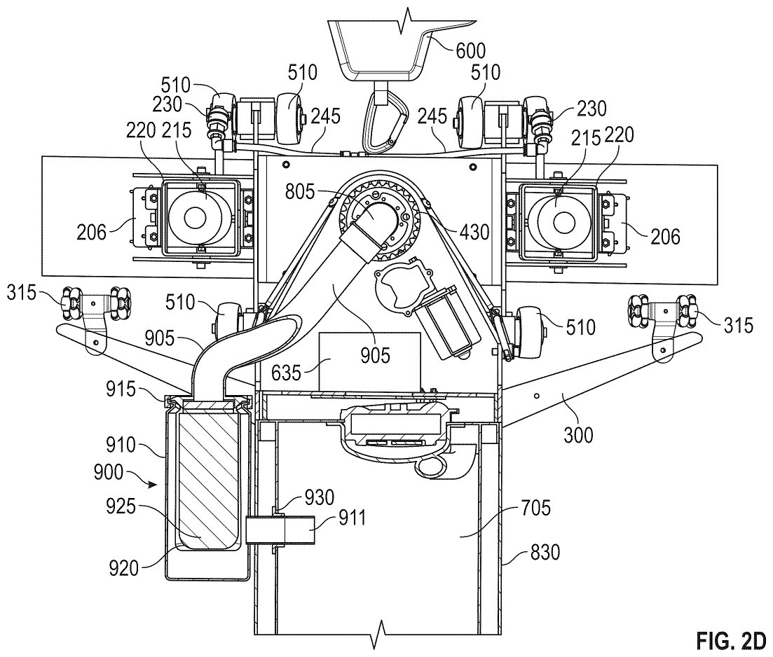

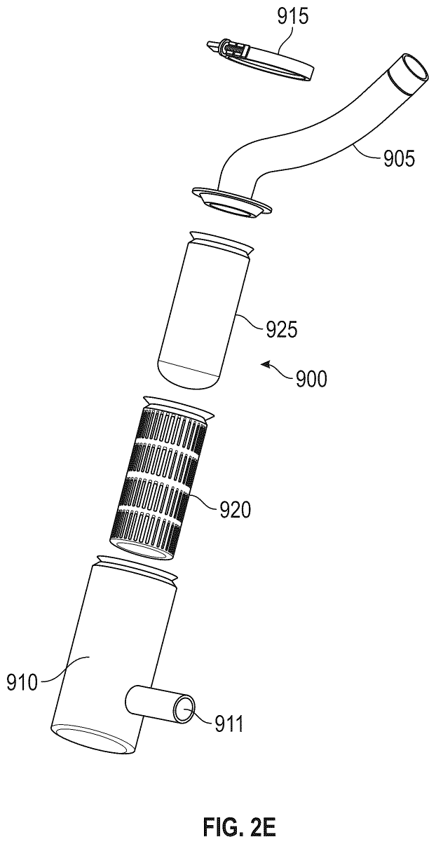

In a more preferred embodiment, shown in FIGS. 1A, 1B, 2B, and 2D, the cleaning apparatus 100 also includes a powered ascender 600, a suspension linkage system 605, a cover 610, a battery 615, a radio control module 620, a rotating vacuum adapter 805, a filter assembly 900, and a lower stabilizing wheel 720. It is preferred that the automated, self-contained cleaning apparatus 100 is a modular design, and when fully assembled, all of the modular parts create a cleaning apparatus that is removably coupled to the high-height, substantially vertical surface.

In the preferred embodiment, the cleaning apparatus 100 is coupled to the powered ascender 600 with a suspension linkage system 605 as shown in FIG. 1A. In the preferred embodiment, the linkage can be flexible or rigid. Examples of preferred flexible materials include steel cables, Dyneema slings, rope, or any other flexible material of suitable strength and size. Examples of rigid linkage systems include a rod or multiple rods, bolts, bent or machined steel, or any other rigid material of suitable strength and size.

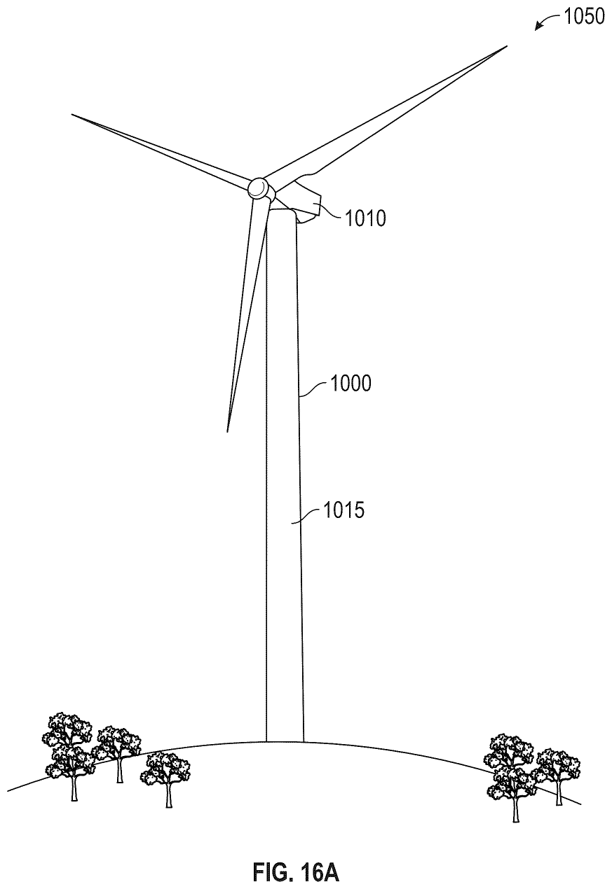

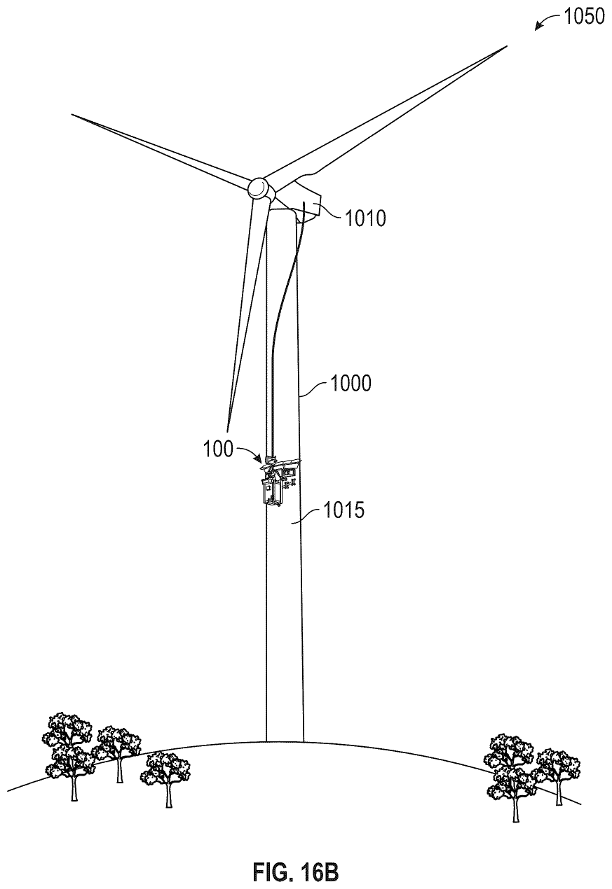

It is preferred that the tower support structure 1000 is made of a ferrous material, such as steel, to which a magnet can attach. A powered ascender 600 is coupled to the cleaning apparatus 100 such that the powered ascender 600 is used to raise and lower the cleaning apparatus 100 along the tower support structure 1000. It is preferred that the powered ascender 600 is rigged to the nacelle 1010 (shown in FIG. 16A and 16B) of the wind turbine tower 1050 using a rope rigging system and hangs from this position when the cleaning apparatus 100 is being used to clean the tower surface 1015. As the cleaning apparatus 100 is repositioned around the circumference of the tower support structure 1000, the nacelle 1010 above the tower support structure 1000 is repositioned accordingly. This way, the cleaning apparatus 100 is not removed and re-rigged every time the cleaning apparatus 100 moves along the circumference of the tower support structure 1000. In the most preferred embodiment of the invention, the cleaning apparatus 100 is remotely steerable and can clean the surface of the tower 1015 in both the up and down directions as it moves along the tower surface 1015.

Preferably, the cleaning apparatus 100 is rigged to the outside of the wind turbine tower 1050 via the powered ascender 600. It is preferred that the powered ascender 600 couple to ropes of a sufficient strength compatible to be used with a powered ascender 600. It is preferred that these ropes are 11 mm static rope. These ropes can be rigged to any structure of sufficient strength, but most preferably are rigged to the nacelle 1010 portion of the wind turbine tower 1050. The cleaning apparatus 100 is then aligned with the soiled portions of the tower surface 1015 using the nacelle 1010 and its corresponding anchors. When the cleaning apparatus 100 needs to move along the circumference of the tower support structure 1050, the nacelle 1010 is moved to allow the cleaning apparatus 100 to realign as required.

When the cleaning apparatus 100 is used on the inside of the tower support structure 1050, the powered ascender 600 is again used as the rigging connection for the cleaning apparatus 100. The same ropes of sufficient strength that are compatible to be used with the powered ascender 600 are used. Inside the tower support structure 1050, however, there is no nacelle 1010. Thus, the ropes are rigged to other structures of sufficient strength inside the tower support structure 1050 to ensure that the cleaning apparatus is safely rigged and is aligned with the soiled portion inside the tower support structure 1050.

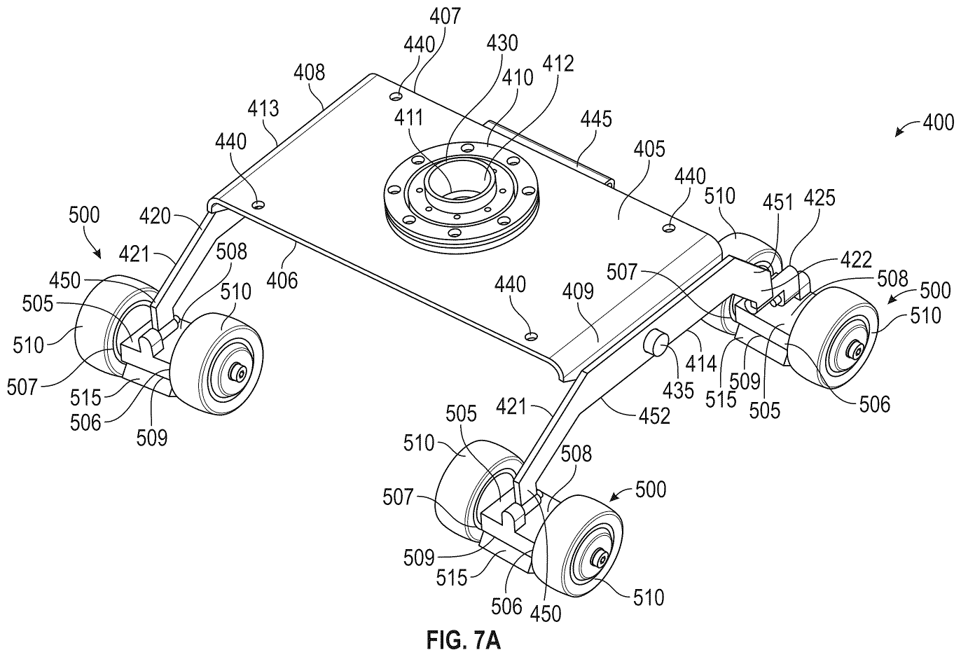

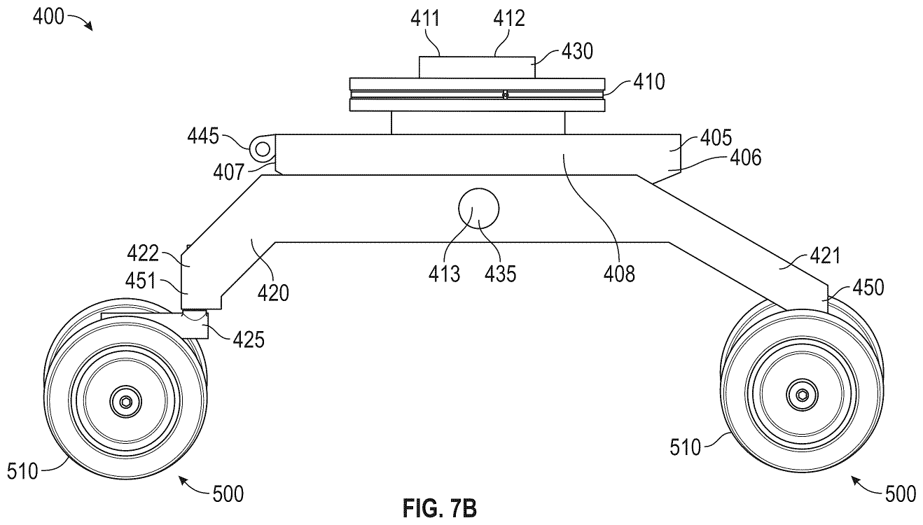

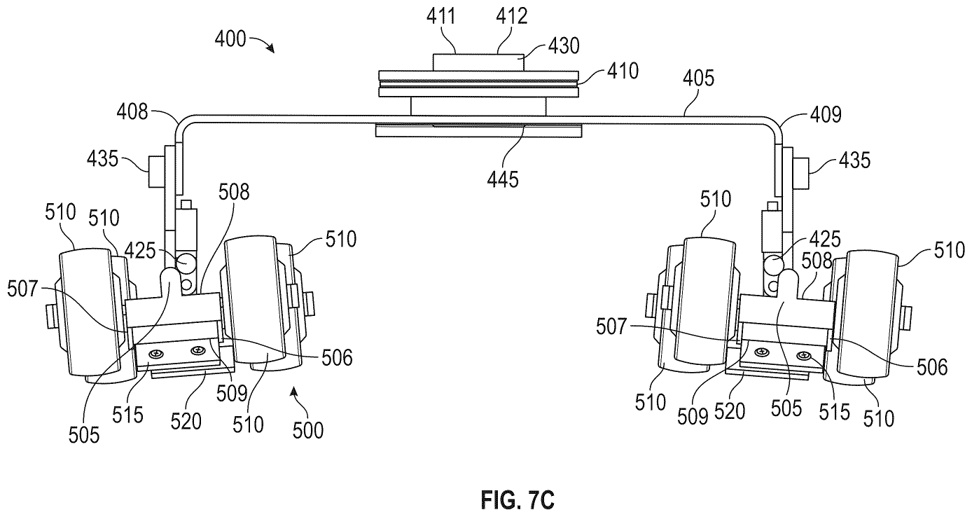

In the preferred embodiment, shown in FIGS. 7A, 7B, and 7C, the rotating platform assembly 400 comprises a rotating platform 405, a bearing 410, a first rocker arm 420, and a second rocker arm 452. Preferably, the bearing 410 has a bearing center 412 and is coupled to the rotating platform center 411 of the rotating platform 405 allowing the rotating platform 405 to rotate around the bearing 410.

In this preferred embodiment, the first rocker arm 420 and the second rocker arm 452 each have a first wheel assembly connection point 450 and a second wheel assembly connection point 451. The first rocker arm 420 is moveably coupled to the rotating platform first side 408, and the second rocker arm 452 is moveably coupled to the rotating platform second side 409. More preferably, the rocker arms 420 and 452 are coupled to the center 413 of the rotating platform first side 408 and the center 414 of the rotating platform second side 409 via respective rotating couplers 435 (not shown for the first rocker arm 420, but this is the mirror image of the second rocker arm 452).

In this preferred embodiment, the rotating coupler 435 couples the rocker arms 420 and 452 to the rotating platform 405 in such a way that when the wheel assemblies 500 roll along the tower surface 1015, the wheel assemblies 500 maintain contact with the tower surface 1015 as the tower surface 1015 is not completely smooth and usually includes weld seams (not shown). When the cleaning apparatus 100 encounters these weld seams, the attachment of the rocker arms 420 and 452 to the rotating platform 405 provides a mechanism that prevents the wheel assemblies 500 from losing contact with the tower surface 1015. In particular, each rocker arm 420 and 452 moves independent of each other allowing the wheel assemblies 500 that are coupled to each rocker arm 420 and 452 to independently articulate based on the surface terrain it is moving over. This becomes important because the tower surface 1015 is not uniform across its width. When the cleaning apparatus 100 is in operation and moving across the non-uniform tower surface 1015, it must maintain proper contact with the tower surface 1015 so as not to detach from the tower support structure 1000.

The rocker arms 420 and 452 aid in keeping the cleaning apparatus 100 in place by articulating and moving independent of each other keeping the wheel assemblies 500 in contact with the tower surface 1015 while the cleaning apparatus 100 remains level with respect to the tower support structure 1000. The rocker arms 420 and 452 also aid in the steerability of the cleaning apparatus 100. In particular, when the cleaning apparatus 100 is turning along the tower surface 1015, the wheel assemblies 500 are at varying elevations along the curvature of the tower surface 1015. The independent movement of the rocker arms 420 and 452 ensure that the wheel assemblies 500 are able to maintain contact with the tower surface 1015 during this time of turning.

In an alternate embodiment of the invention, not shown, the cleaning apparatus 100 does not rotate. In this embodiment, the platform assembly 400 does not include a bearing 410 on the platform 405, and the cleaning apparatus 100 only moves in one direction on the tower support structure 1000. In this configuration, the cleaning apparatus 100 is moved up and down the tower support structure 1000 in the same way as in the rotating platform 405 configuration, but cleaning in both the up and down path along the tower surface 1015 is not preferred because the scrubber assembly 200 and the wiper assembly 300 are typically not able to be configured to operate as the cleaning apparatus 100 moves down the tower support structure 1000. In this embodiment, it is preferred that the scrubber assembly 200 and the wiper assembly 300 are detached from the tower surface 1015 on the way down to reduce friction and prevent degradation of the scrubber assembly 200 and wiper assembly 300 parts when they are not being used.

As shown in FIG. 7C, each wheel assembly 500 comprises an articulating wheel base 505, a plurality of non-magnetic wheels 510, and at least one magnet 515. Each articulating wheel base 505 includes an apparatus side 508, a surface side 509, an articulating wheel base first side 506, and an articulating wheel base second side 507. The non-magnetic wheels 510 are coupled to the articulating wheel base first side 506 and articulating wheel base second side 507, respectively.

The articulating wheel base 505 allows multiple degrees of freedom of movement of the non-magnetic wheels 510 and magnets 515 such that the non-magnetic wheels 510 and magnets 515 can navigate the uneven tower surface 1015 without the non-magnetic wheels 510 or magnets 515 losing contact with the tower surface 1015. The articulating wheel base 505 additionally provides movement to accommodate the shape of the tower support structure 1000, for example, a conical shape, to maintain contact. The wheel base 505 freedom of movement is further aided by the rotating platform assembly 400, and particularly, the rocker arms 420 and 452 to which the wheel assembly 500 is attached.

As seen in FIGS. 7A, 7B, and 7C, it is preferred that there are four wheel assemblies 500 that are configured as two pairs, and each wheel assembly 500 is coupled to each of the rocker arms 420 and 452 of the rotating platform 405. The first pair of wheel assemblies 500 is coupled at the first wheel assembly connection point 421 of the rocker arms 420 and 452, and the second pair of the wheel assemblies 500 is coupled at the second wheel assembly connection point 422 of the rocker arms 420 and 452 (not shown for the first rocker arm 420, but shown on the second rocker arm 452 that is a mirror image). This configuration provides stability and steering ability of the cleaning apparatus 100 while on the tower support structure 1000.

It is preferred that each of the second wheel assembly connection points 451 is a 2-axis wheel adapter 425. The 2-axis wheel adapters 425 allow the attached wheel assemblies 500 to move on two axes, providing the ability to steer the cleaning apparatus 100 along the tower surface 1015. Specifically, in the most preferred configuration, the rotating platform 405 is capable of rotating in a full 360 degrees (360°) direction around the bearing 410 to allow the cleaning apparatus 100 to be steered up and down the tower support structure 1000 for cleaning in both directions. This provides a more efficient use of the cleaning apparatus 100 because it does not need to be brought to the ground and manually reset to clean up the tower support structure 1000.

In the preferred embodiment, at least one magnet 515 is coupled to the articulating wheel base 505. It is more preferred that there is a plurality of magnets 515 that are coupled to the articulating wheel base surface side 509. In the most preferred embodiment, there are two magnets 515 coupled to each articulating wheel base surface side 509 on each wheel assembly 500.

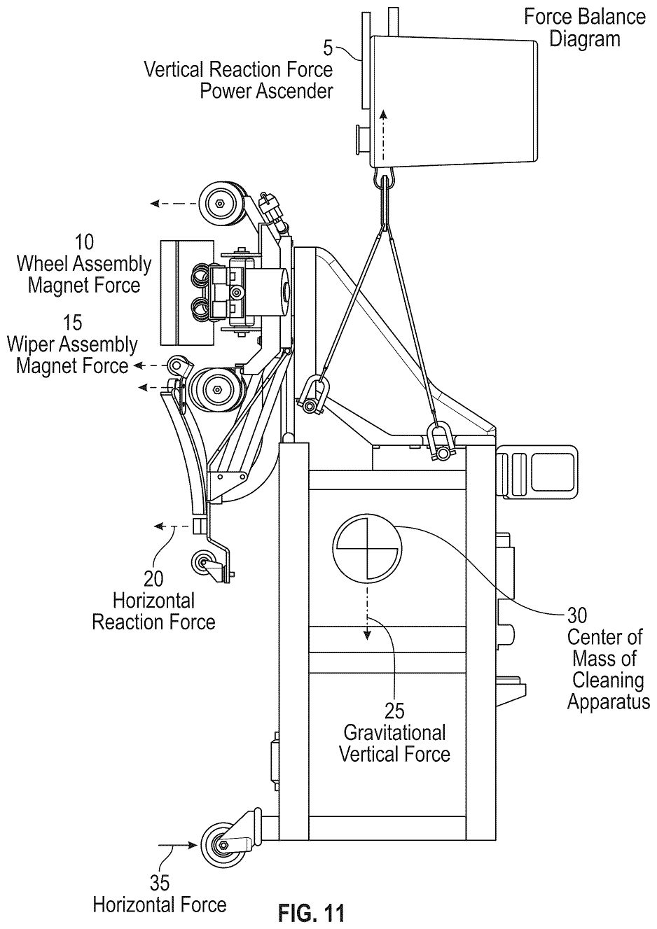

In this preferred embodiment, the magnets 515 are the primary mode of coupling the cleaning apparatus 100 to the tower surface 1015. While the magnets 515 may be of any type to provide removeable coupling of the cleaning apparatus 100 to the tower surface 1015, it is preferred that the magnets 515 are configured in such a way to create a high powered magnetic circuit 515. The magnets 515 provide a force that is perpendicular to the tower support structure 1000 (as seen in the force body diagram of FIG. 11) causing the magnets 515 to maintain a force sufficient to hold the cleaning apparatus 100 to the tower surface 1015 while in use under varying conditions.

As seen in the force body diagram of FIG. 11, there are several competing forces of the cleaning apparatus 100 that must be balanced in order to ensure that it remains in contact with the tower surface 1015. In particular, there is a gravitational vertical force 25 of the cleaning apparatus 100, a vertical reaction force 5 caused by the power ascender 600, a wheel assembly magnet force 10 that is in the direction of the tower support structure 1000, a wiper assembly magnet force 15 that is in the direction of the tower support structure 1000, a horizontal reaction force 20 in the direction of the tower support structure 1000, and a horizontal force 35 away from the tower support structure 1000. These forces work around the center of gravity 30 of the cleaning apparatus 100.

It is preferred that the magnets 515 are arranged to create high powered magnetic circuits that provide an exact amount of force to be applied to removably couple the cleaning apparatus 100 to the tower surface 1015 based on the weight of the cleaning apparatus 100, the wind speed, and any other environmental factors that come into play. The arrangement of the magnets 515 to create a circuit is preferred because the natural properties of the magnets 515 allows for a calculated, exact magnetic circuit force to be applied based on the outside factors. By arranging the magnets 515 to create a circuit, the force of the magnets can be increased without adding more magnets, and therefore, there is less bulk and weight added to the cleaning apparatus 100.

The air gap distance of the circuit magnets 515 with respect to the tower surface 1015 is critical because the air gap affects the pull-off force of the magnets 515. The air gap is part of the magnetic circuit created by the magnets 515. If the magnets 515 are too close to the tower surface 1015, they will crash into elevated components of the tower surface 1015 such as weld seams (not shown), and if the magnets 515 are too far from the tower surface 1015, the magnetic force holding the cleaning apparatus 100 to the tower support structure 1000 will be reduced so that the magnets 515 are ineffective. Therefore, an acceptable air gap must be maintained to provide the proper coupling force while at the same time preventing contact with the elevated portions of the tower surface 1015. The most preferred total attachment force of the circuit magnets 515 is 440 Newtons (99 lbf) with an air gap of 3.3 mm (0.13 in) per wheel assembly 500. The air gap can range between 0-20 mm. The range of acceptable force is 356-445 Newton (80-100 lbf). This, however, can change depending on the cleaning apparatus 100, tower surface 1015, and other factors mentioned.

In the preferred embodiment, the magnets 515 are fitted with a rub block 520 that provides low friction contact with the tower surface 1015 if an elevated surface, such as a weld seam, becomes positioned between the non-magnetic wheels 510. The rub block 520 is preferably a low friction, polymer slider that prevents contact between the tower surface 1015 and the magnets 515 and will not damage the tower surface 1015. It is preferred that the rub block 520 is made of an ultra-high molecular weight polyethylene (UHMWP) but can be made of any other suitable material with the same properties.

It is preferred that the magnets 515 are located between the non-magnetic wheels 510 in order to prevent the magnets 515 from coming into direct contact with the tower surface 1015. This is done to protect the magnets 515 and the tower surface 1015 from damage. The preferred non-magnetic wheels 510 measure 7.6 cm (3 inches) diameter with a circumference of 24 cm (9.425 inches). The non-magnetic wheels 510 can range from 50 mm-200 mm. Moreover, it is more preferred that the magnets 515 are angled front to back to keep them within the circumference of the non-magnetic wheels 510. The preferred angle tilt measurement of the magnets 515 is 32° inward in relation to rotating platform 405 from horizontal. Due to the curvature of the tower support structure 1000, the preferred range of the angle tilt measure of the magnets 515 is 0 degrees to 60 degrees (0°-60°) where 0 degrees (0°) is horizontal to the tower surface 1015. The angle of the magnets 515 is based on fitting the two magnets 515 inside the profile of the non-magnetic wheels 510 so that the wheel assembly 500 can easily move over welds on the tower surface 1015 without contacting the tower surface 1015. The actual angle, however, is a variable depending on the size of the non-magnetic wheel 510. The larger the non-magnetic wheel 510, the shallower the magnet 515 angle becomes. With a shallower angle, the magnets 515 can get closer to the tower surface 1015. This reduces the required magnet strength to get the necessary force to maintain contact between the cleaning apparatus 100 and the tower surface 1015.

The center of gravity 30 (shown in FIG. 11) of the tank 705 and cable tension from the suspension linkage system 605 produce torque, and the 2-axis wheel adapters 425 allow the non-magnetic wheels 510 on the second wheel assembly connection point 422 of the rocker arms 420 and 452 to follow. In this configuration, because the cleaning apparatus 100 can rotate in 360° fashion, the cleaning apparatus 100 can be used with a minimum of one scrubber assembly 200 and one wiper assembly 300.

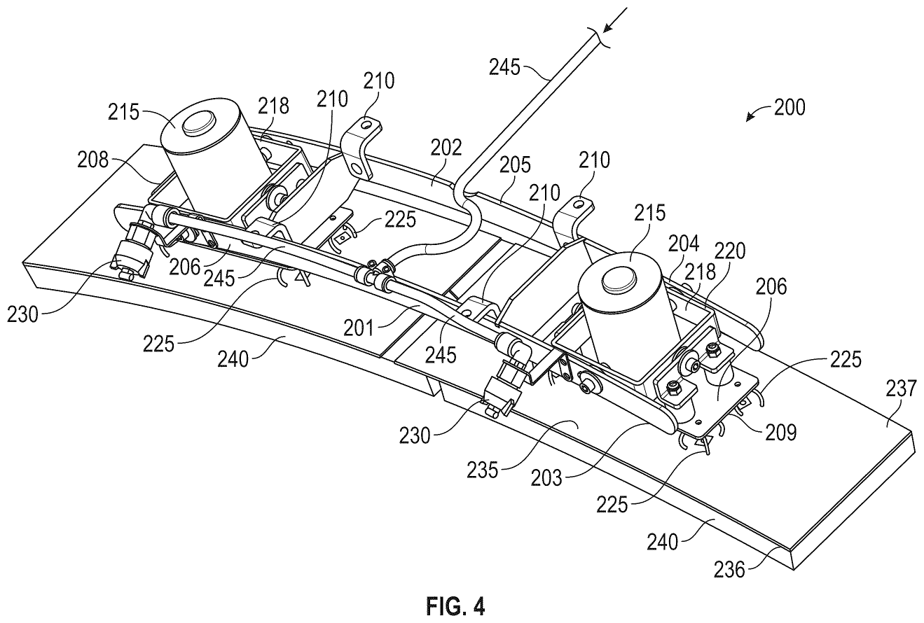

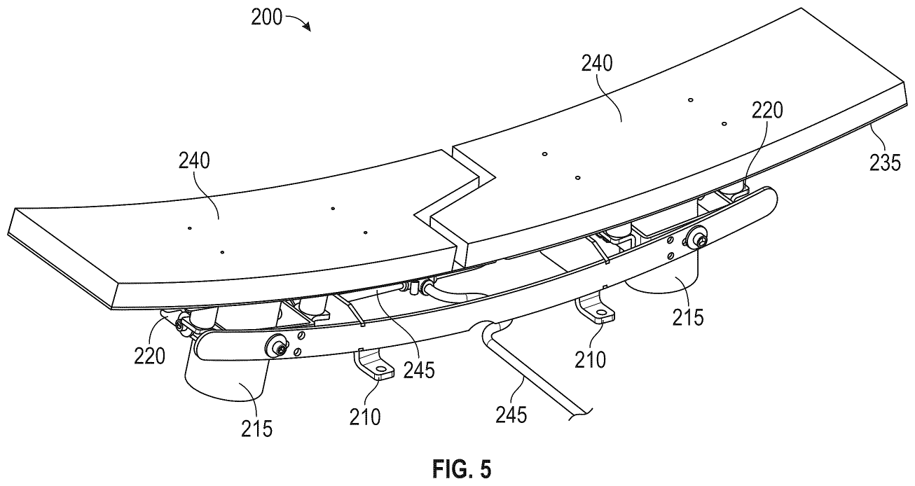

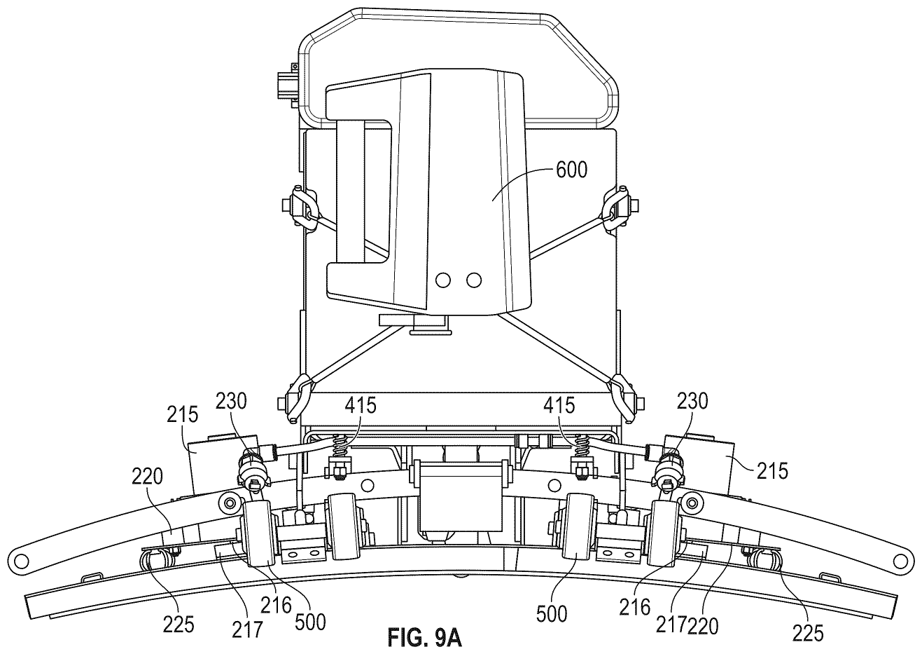

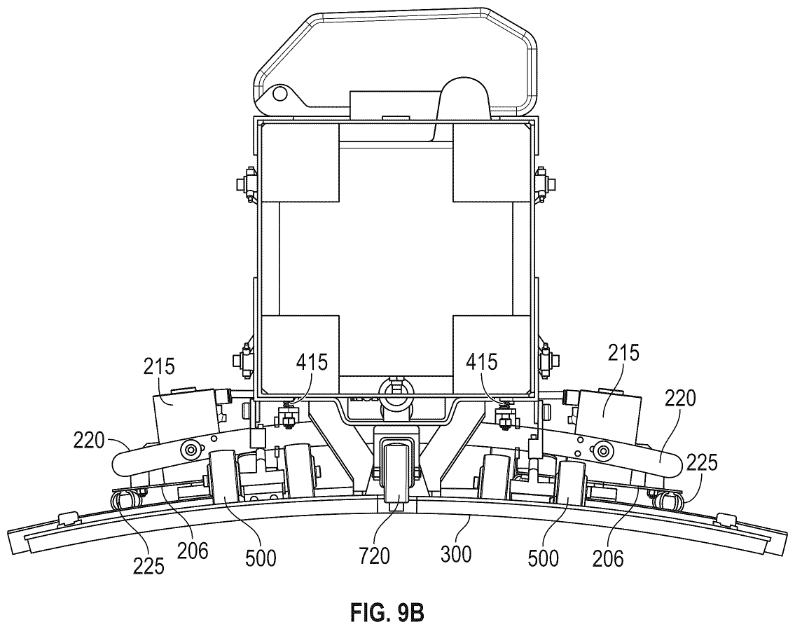

With regard to the scrubber assembly 200, as seen in FIGS. 4 and 5, the scrubber assembly 200 comprises a scrubber backing plate 235, a bracket 205 with at least one mounting tab 210, at least one scrubber preload spring 415 (shown in FIGS. 9A and 9B), fluid distribution tubing 245 with at least one fluid dispensing device 230, a scrubber pad 240, and at least one motor 215. These elements combine to create the scrubber assembly 200 that couples to the rotating platform assembly 400.

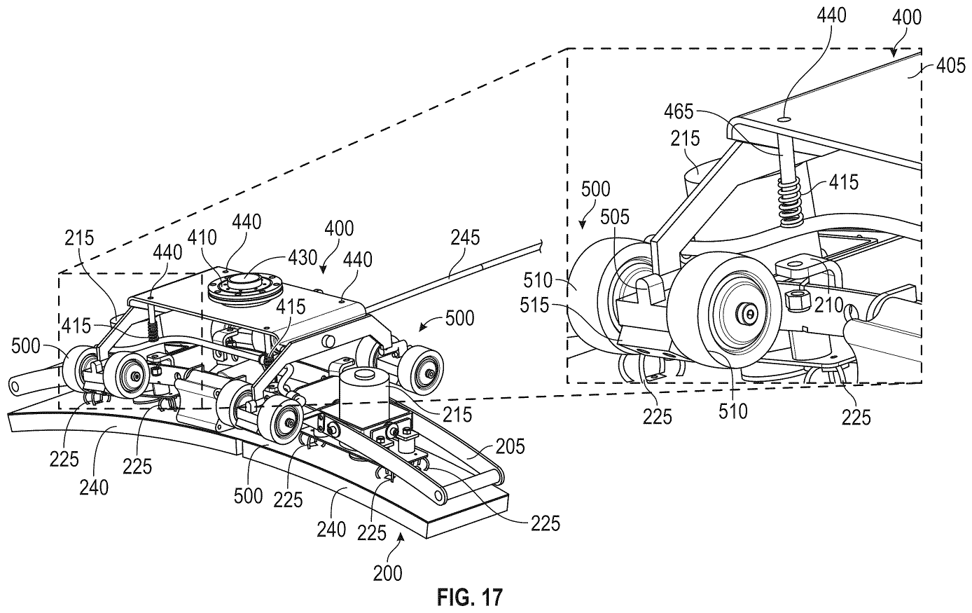

In the preferred embodiment, the scrubber backing plate 235 is removably attached to the rotating platform 400 via the mounting tabs 210 on the bracket 205 and at least one scrubber preload spring 415 that is coupled to the bracket 205, as seen in FIGS. 9A and 9B. It is most preferred that there are four scrubber preload springs 415 that are attached through the connection holes 440 (shown in FIGS. 7A and 17) on the rotating platform 405 and couple into the mounting tabs 210 on the bracket 205. These scrubber preload springs 415 are not only a connection point, but they also provide a perpendicular force to the tower support structure 1000 to keep the scrubber pad 240 in contact with the tower surface 1015 while the cleaning apparatus 100 is in use. The preload springs 415, however, can be any type of device that provides a force to engage contact between the scrubber pad 240 and the tower surface 1015. In addition, the scrubber pad 240 can be disengaged from the tower surface 1015 when it is not in an active cleaning mode. This reduces the friction when the scrub pad 240 is not necessary (i.e. when placing the machine on the tower support structure) and prevents premature wearing of the scrub pad 240 when not needed.

In the preferred embodiment, as shown in FIG. 4, the scrubber pad 240 is attached to the scrubber backing plate front side 236. It is preferred that this attachment is such that the scrubber pad 240 can be easily removed from the scrubber backing plate 235 when the scrubber pad 240 needs to be changed when it wears out. This attachment can be a hook and loop type fastener or any other fastening mechanism that is strong enough to keep the scrubber pad 240 in place during use while allowing removal for disposal. The scrubber backing plate 235 and the scrubber pad 240 can be one piece, but in the preferred configuration, they are two pieces that are not directly coupled, as seen in FIGS. 4 and 5. Preferably, they may be separated by any cut, but more preferably, they are separated with a vertical cut, but it is more preferred that they are cut at a scarf cut angle. This scarf cut configuration allows the scrubber pad 240 to engage the entire surface over which it is traveling and cleaning without leaving a thin trail down the center of the tower surface 1015 that has not been scrubbed.

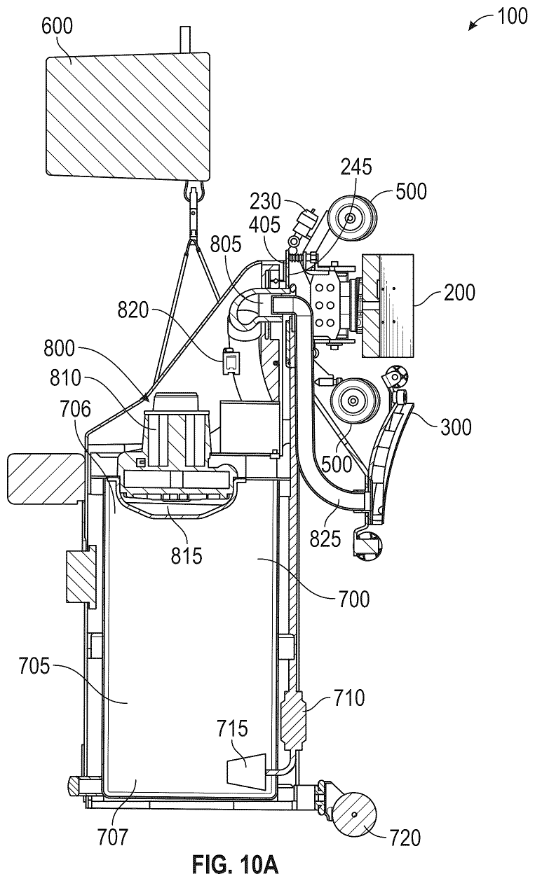

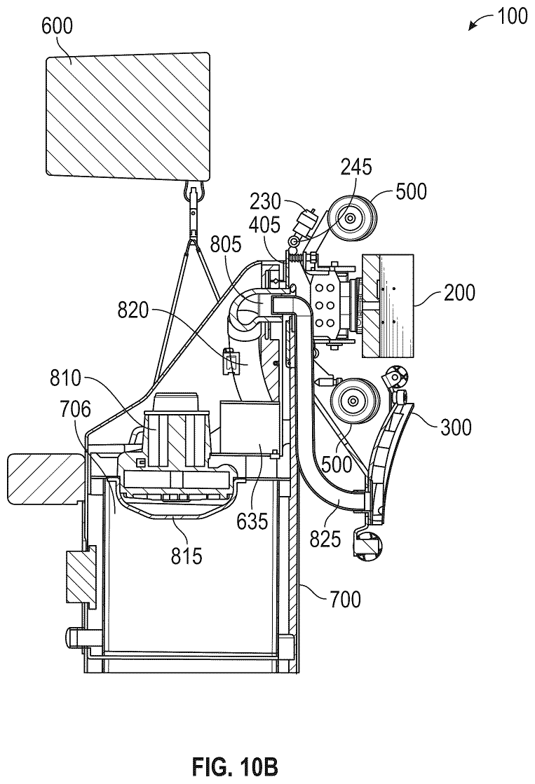

As shown in FIGS. 10A and 10B, it is preferred that the cleaning solution is dispensed from the tank 705 using a pump 825 that pumps the cleaning solution through the fluid distribution tubing 245 and sprays onto the tower surface 1015 out of the attached fluid dispensing devices 230. In the preferred embodiment, the fluid dispensing device 230 may be a nozzle, a spray bar, a perforated jet line, or some other similar device. The cleaning solution can be water or a combination of soap, water, or any other chemical that can clean the dirt and grease off of the tower surface 1015. It is preferred that these fluid dispensing devices 230 are attached to the fluid distribution tubing 245 as shown in FIG. 4, and the fluid distribution tubing 245 comes up from the tank 705 and runs along the bracket top side 201. The fluid dispensing devices 230 dispense the cleaning solution onto the tower surface 1015 while the scrubber pad 240 oscillates to effectuate the cleaning of the tower surface 1015. In a most preferred embodiment, the environmental conditions can be factored and calculated to optimize the fluid dispensing devices 230 to have the most efficient spray by preventing the loss of the cleaning solution to the wind and evaporation.

As the cleaning apparatus 100 moves in a vertical direction on the tower support structure 1000, a motor 215 coupled to the scrubber backing plate 235 causes the scrubber backing plate 235, and, in turn, the scrubber pads 240 to oscillate along the tower surface 1015. This oscillation motion causes the scrubber pads 240 to clean along the tower surface 1015 in conjunction with the cleaning solution being dispensed from the fluid dispensing devices 230.

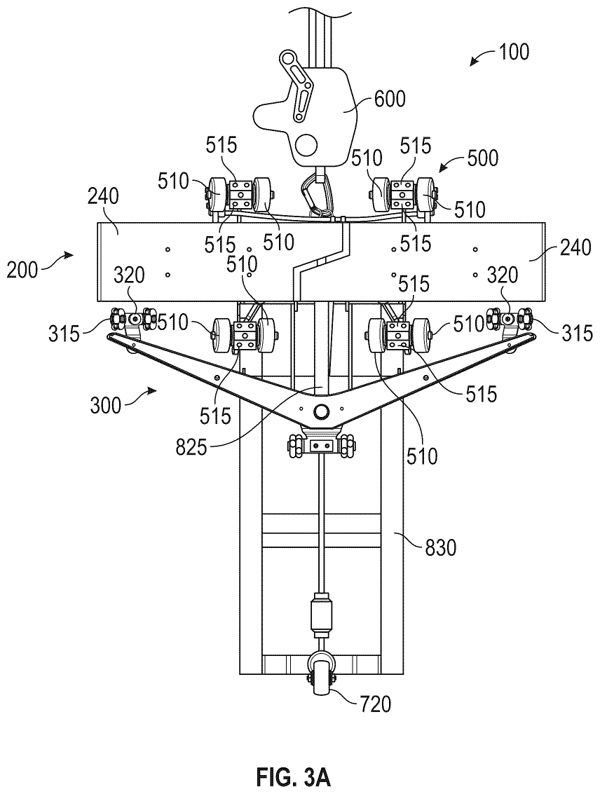

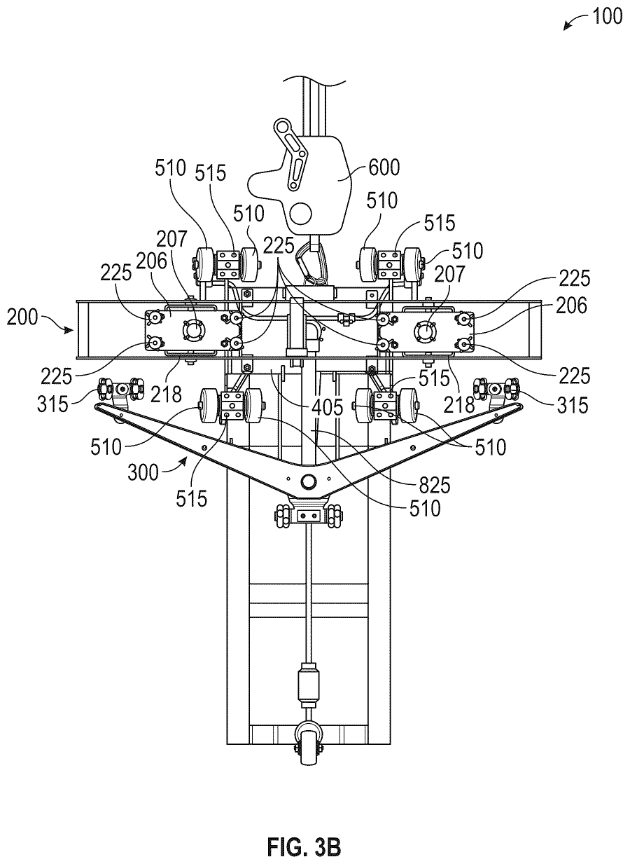

In the preferred embodiment, as seen in FIGS. 4, 9A, and 9B, a motor assembly 218 comprises a motor 215, a shaft 216, and an eccentric plate mount 217 that is coupled to the shaft 216. The motor 215, shaft 216, and eccentric plate mount 217 are attached to a motor gimbal 220 that attaches to the bracket 205 and a motor face plate 206. The motor face plate 206 includes a hole 207 (FIG. 3B) where the shaft 216 extends through the hole 207 and couples to the eccentric plate mount 217 that connects to the scrubber backing plate backside 237. The motor face plate 206 is coupled to the scrubber backing plate 235 with at least one vibration isolator 225.

The eccentric plate mount 217 causes the energy from the shaft 216 of the motor 215 to provide oscillation movement to the scrubber backing plate 235. This allows the scrubber pads 240 to move along the tower surface 1015 in a way that agitates the dirt and grease on the tower surface 1015 so that the dirt and grease can easily be removed by the wiper assembly 300. The motor gimbal 220 attaches to the bracket 205 and the motor face plate 206 and allows the motor assembly 218 to move in this oscillating manner while allowing each scrubber pad 240 to articulate to the tower surface 1015. In other words, the scrubber pad 240 stays in a stable position in contact with the tower surface 1015 regardless of the positions of the other parts of the cleaning apparatus 100 because of the motor gimbal 220.

Moreover, in the preferred embodiment, the motor face plate 206 includes a hole 207 through its center where the shaft 216 can extend through, couple to the eccentric plate mount 217, and contact the scrubber backing plate backside 237. The motor face plate 206 is coupled to the scrubber backing plate 235 via at least one vibration isolator 225. It is preferred that the vibration isolator 225 is a wire rope isolator to provide additional durability and safety. However, the vibration isolator 225 could also be a standard rubber vibration isolator. The vibration isolator 225 allows freedom of movement in all directions while maintaining the coupling of the motor face plate 206 to the scrubber backing plate 235.

In the preferred embodiment of the invention, the scrubber assembly 200 includes two motor assemblies 218. One motor assembly 218 is positioned at the bracket first end 208, and the second motor assembly 218 is positioned at the bracket second end 209. This configuration allows each motor assembly 218 to be positioned on each scrubber backing plate backside 237 to provide oscillating movement to each individual scrubber backing plate 235 and associated scrubber pad 240 as seen in FIGS. 4, 9A, and 9B. Moreover, it is preferred that the scrubber assembly 200 fits within a distance between the wheel assemblies 500 on each of the first and second rocker arms 420 and 452.

Moreover, the scrubber backing plate 235 can be either in a substantially concave or convex shape. This allows the cleaning apparatus 100 to be used either on the inside or the outside of the tower support structure 1000 by accommodating the change of shape between either concave or convex. Depending on the surface to be cleaned, the properly shaped scrubber assembly 200 is selected and coupled to the rotating platform assembly 400 as described.

In the preferred embodiment, the shape of the scrubber backing plate 235 is important. In particular, the scrubber backing plate 235 and associated scrubber pad 240 are shaped in such a way that they conform to a curved surface (i.e. the curved surface of the tower 1015) while the scrubber backing plate 235 is still able to rotate orbitally. In the preferred embodiment, the scrubber backing plate 235 is made of rolled titanium. The material properties of the rolled titanium allow the scrubber backing plate 235 to constrict and relax to the tower support structure's 1000 variable diameter as the cleaning apparatus 100 moves vertically on the tower surface 1015. The rolled titanium plates are rigid enough to provide support to the scrubber pad 240, but at the same time, light enough not to over burden the scrubber assembly motor 215.

During articulation of the scrubber backing plate 235 when the cleaning apparatus 100 is rotating around the rotating platform assembly 400, it must be able to conform to the curved surface of the tower support structure 1000, but also must be flexible enough to slightly deform while completing the rotation. When cleaning flat surfaces, and inside/outside tower surfaces 1015, as the scrubber backing plate 235 takes the shape of the surface being cleaned, this deformation must not exceed the material's yield strength. This provides for multiple materials that could be utilized, including the current preference for titanium. Other materials that can be utilized are stainless steel, aluminum, other various metals or polymers.

The scrubber assembly motor 215 can be powered using one or more batteries or an extended cord to provide power. In the preferred embodiment, the power supply is a rechargeable battery 615 that is located on the structural frame assembly 830 shown in FIGS. 1A and 1B. The oscillation of the scrubber pad 240 via the motor 215 works to emulsify dirt and grease on the tower surface 1015. As the cleaning apparatus 100 continues to move along the tower surface 1015, the dirty water is preferably collected by the wiper assembly 300 that is attached to the rotating platform assembly 400 and is below the scrubber assembly 200. The wiper assembly 300 collects the dirty water through a vacuum adapter port 350 and returns it to the tank 705 through a lower vacuum hose 825 as shown in FIG. 10A. In the preferred embodiment, the dirty water is put through a filter 715 and is reused as cleaning solution as the cleaning apparatus 100 continues cleaning the tower surface 1015.

In the preferred embodiment, the wiper assembly 300 is located below the scrubber assembly 200 and is preferably attached to the rotating platform assembly 400 with a system that allows front-to-back articulation with limited side-to-side motion as shown in FIGS. 1A and 1B. Moreover, this system, along with the at least one magnet 320 on the guide wheel assembly 315, provides force in the direction of the tower support structure 1000 in order that the wiper assembly 300 maintains contact with the tower surface 1015 while the cleaning apparatus 100 is in use. Any type of contemplated connection can be used that provides the proper fastening and movement.

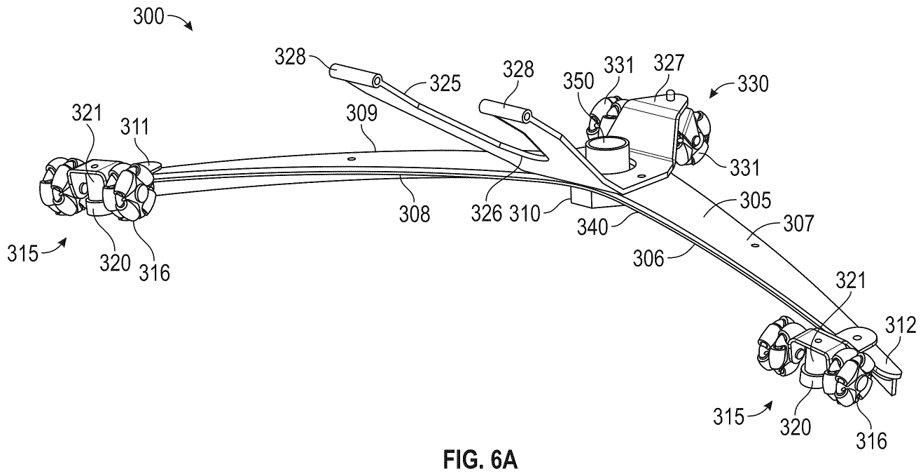

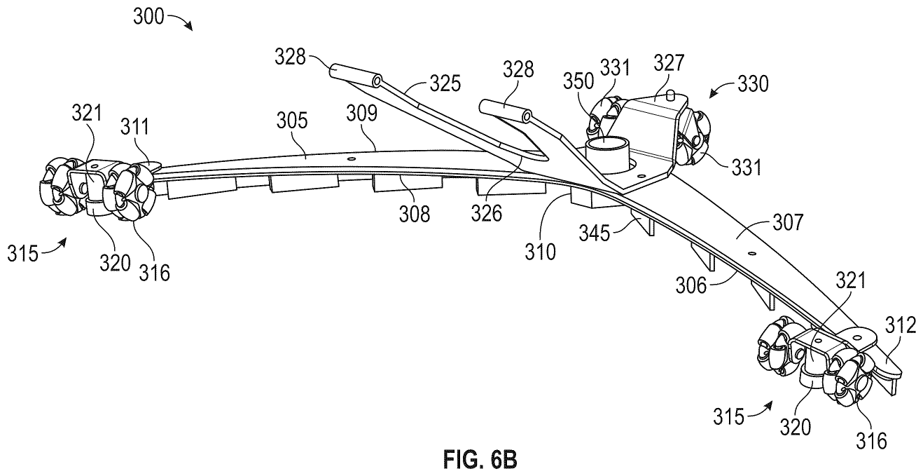

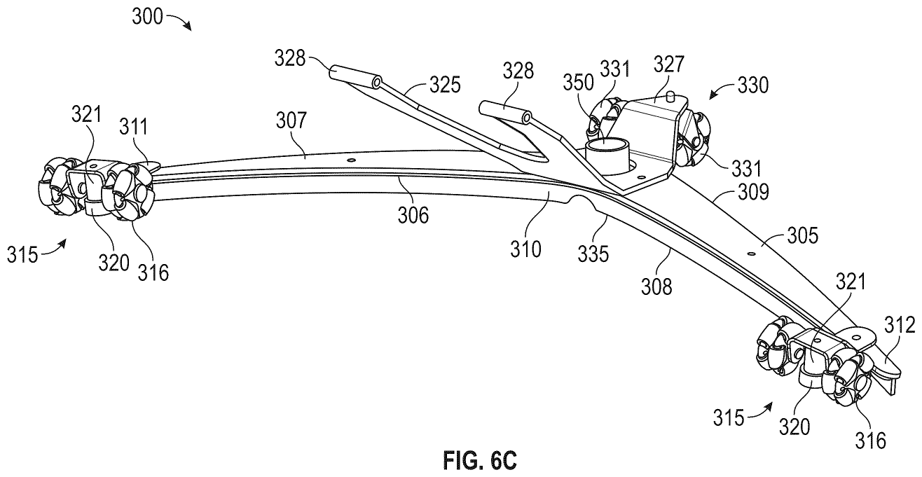

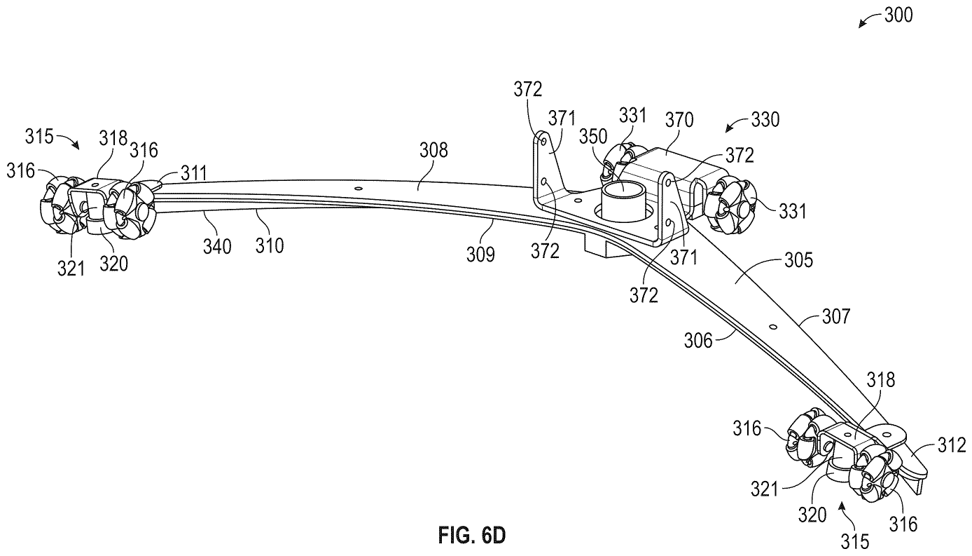

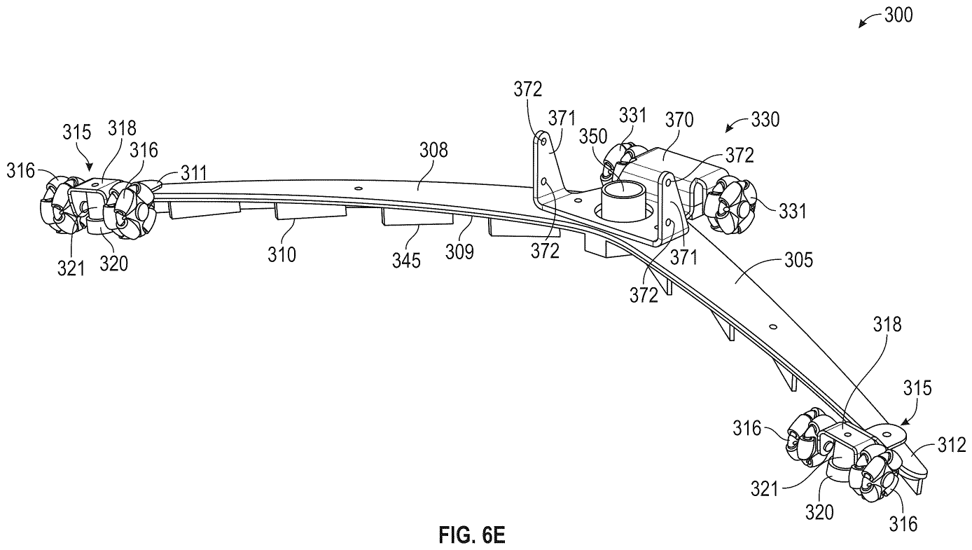

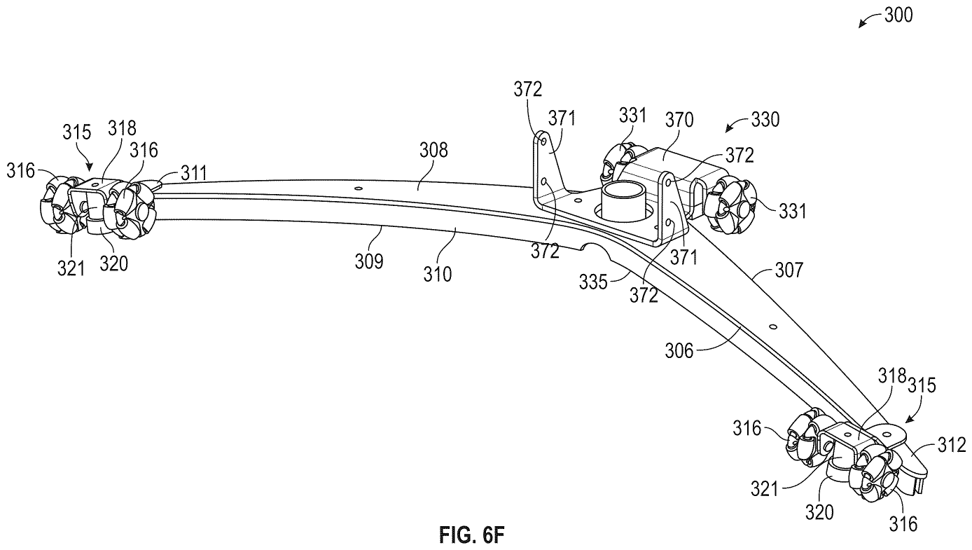

In one preferred embodiment, the wiper assembly 300 comprises a wiper element 310, a flexible support 305, a structural attachment bracket 325, at least one guide wheel assembly 315, and a wiper trailing wheel assembly 330 as shown in FIGS. 6A-6C. In an alternate preferred embodiment, the wiper assembly 300 comprises a wiper element 310, a flexible support 305, a trailing bracket 370, at least one guide wheel assembly 315, and a wiper trailing wheel assembly 330 as shown in FIGS. 6D-6F.

It is preferred that the flexible support 305 is made of a supportive yet flexible material, such as metal or plastic, and includes a vacuum adapter port 350. The vacuum adapter port 350 couples to the rotating vacuum adapter 805 (shown in FIGS. 2A, 2B, and 2C) on the flexible support backside 306 and connects the lower vacuum hose 825 to the upper vacuum hose 820 (shown in FIGS. 10A and 10B). This allows the dirty water captured by the wiper assembly 300 from the tower surface 1015 to be funneled back into the tank assembly 700 for recycling and reuse, as shown in FIGS. 10A and 10B.

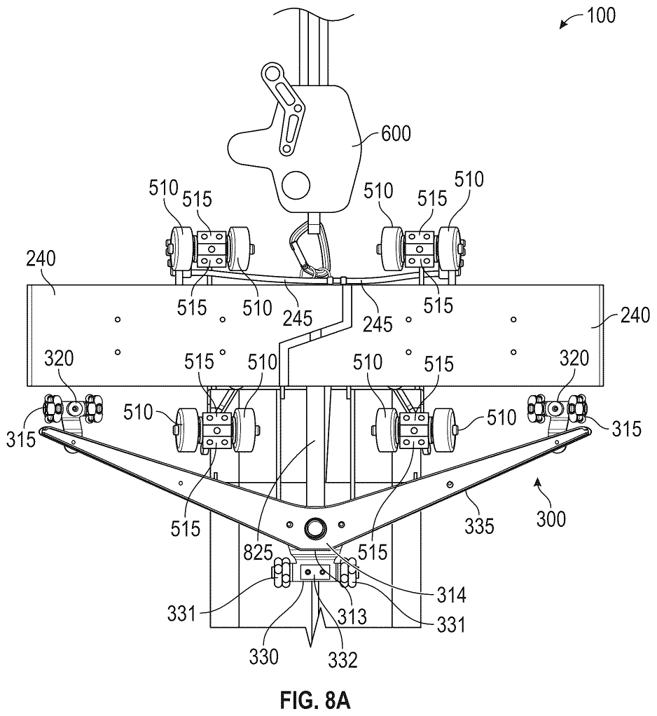

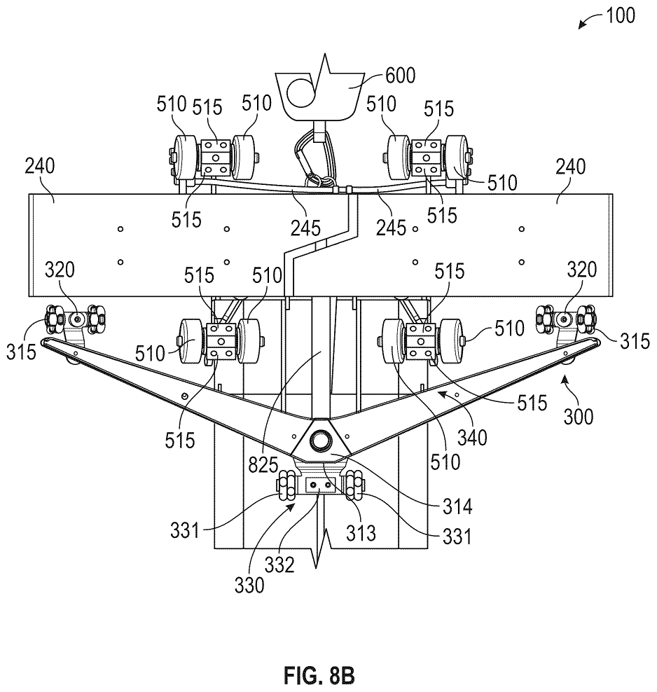

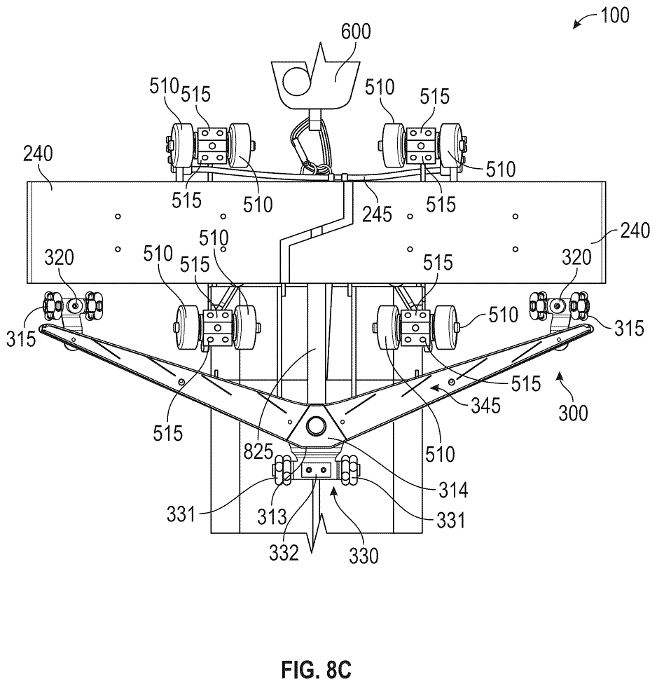

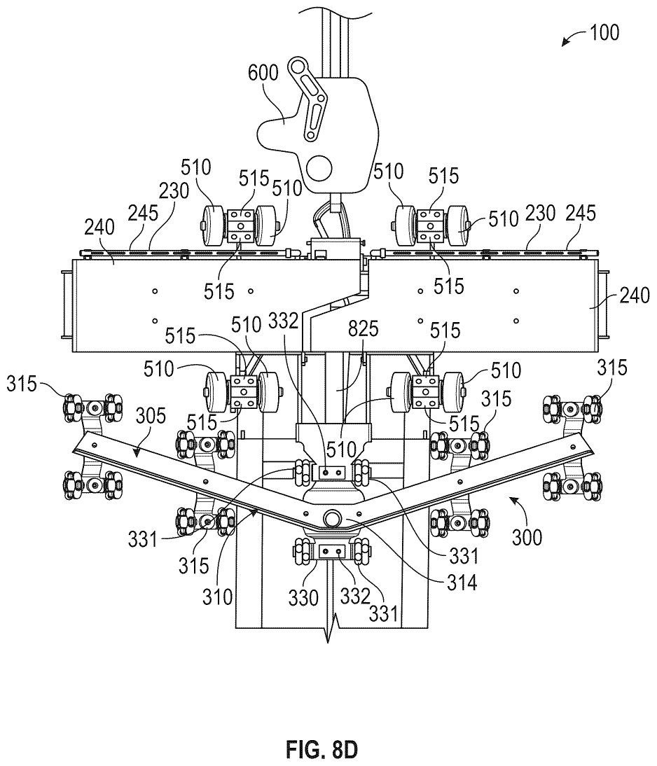

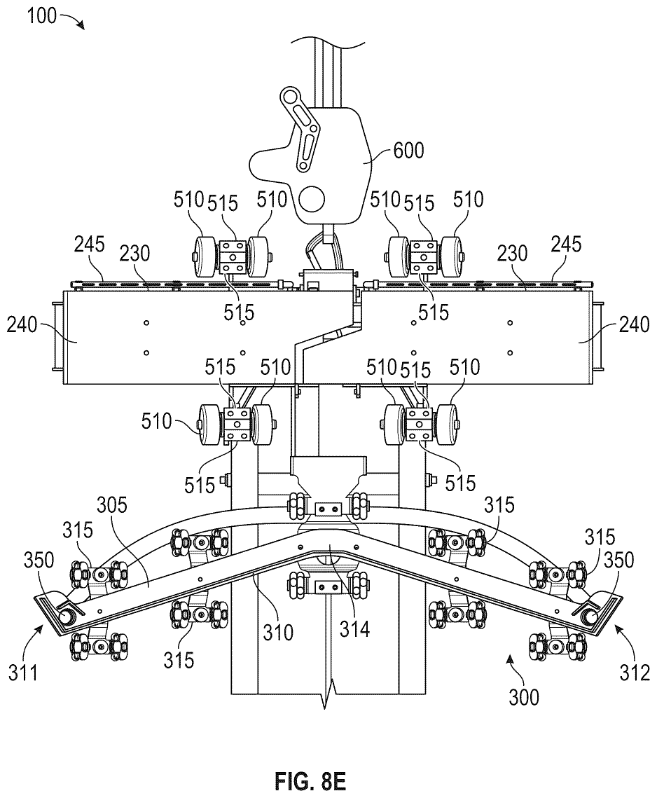

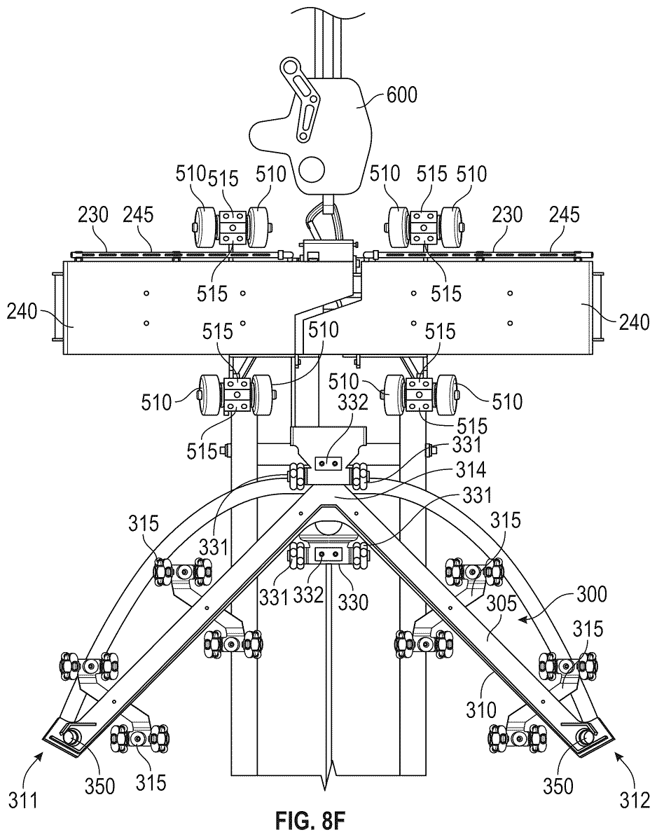

In the preferred embodiment, the wiper element 310 is removably attached to the flexible support front side 306 because it must be changed at some frequency as it deteriorates through use. The wiper element 310 is attached to the flexible support 305 via fasteners that maintain the integrity of the device while the cleaning apparatus 100 is in use but allows easy removal and replacement of the wiper element 310. Examples of these fasteners include, but are not limited to, screws, clamps, or pins. As shown in FIGS. 6A, 6B, 6C, 6D, 6E, 6F, 8A, 8B, 8C, 8D, 8E, and 8F the wiper element 310 can take on different embodiments. In particular, the wiper element 310 can be a leading and trailing wiper 335, as shown in FIGS. 6A, 6F, and 8A, a trailing wiper 340, as shown in FIGS. 6A, 6D, and 8B, a trailing wiper with intermittent wipers 345, as shown in FIGS. 6B, 6E, and 8C, or leading wiper (not shown). These configurations can be changed depending on conditions via the removable coupling mechanism of the flexible support 305.

Preferably, the wiper element 310 is made of a flexible material that allows the wiper element 310 to effectively collect dirty water and material from the tower surface 1015 and channel it through the vacuum adapter port 350 and through the upper vacuum hose 820 and lower vacuum hose 825. Moreover, the shape of the wiper element 310 and corresponding flexible support 305 may be important to the overall collection of the dirty water. A flat wiper element bottom 313, as shown in FIGS. 8A, 8B, and 8C, is preferred to effectuate collection of the dirty water to prevent runs or drips being left behind on the tower surface 1015 when the wiper element 310 is pulled over unique features on the tower surface 1015, such as weld seams. The wiper element 310 must be large enough to move over the weld seams on the tower surface 1015, and is preferably made of a material, such as rubber, polyurethane, silicone, or any other proper material that is rigid enough to remove fluid from the tower surface 1015 but pliable enough to conform to the curved shape of the tower support structure 1000.

Further, in one embodiment, the wiper assembly 300 comprises a structural attachment bracket 325, as seen in FIGS. 6A, 6B, and 6C. Preferably, the structural attachment bracket 325 is coupled to the flexible support backside 307 and the structural attachment bracket front end 326 extends past the structural support top side 308, and the structural attachment bracket back end 327 extends past the structural support bottom side 309. In a preferred embodiment, the structural attachment bracket front end 326 is a “U” shaped configuration and includes a structural attachment bracket rotating coupler 328 that couples to the rotating platform assembly wiper assembly connection 445 located at the rotating platform second end 407 as shown in FIGS. 7A and 7B. It is preferred that a pin fastener is used to allow freedom of movement at this connection point. This coupling mechanism allows the wiper assembly 300 to move with respect to the rotating platform assembly 400 as the cleaning apparatus 100 moves along the tower surface 1015. As the cleaning machine 100 encounters different levels of terrain over the tower surface 1015, the wiper assembly 300 moves in conjunction with the rotating platform 400 and scrubber assembly 200 and maintains contact with the tower surface 1015.

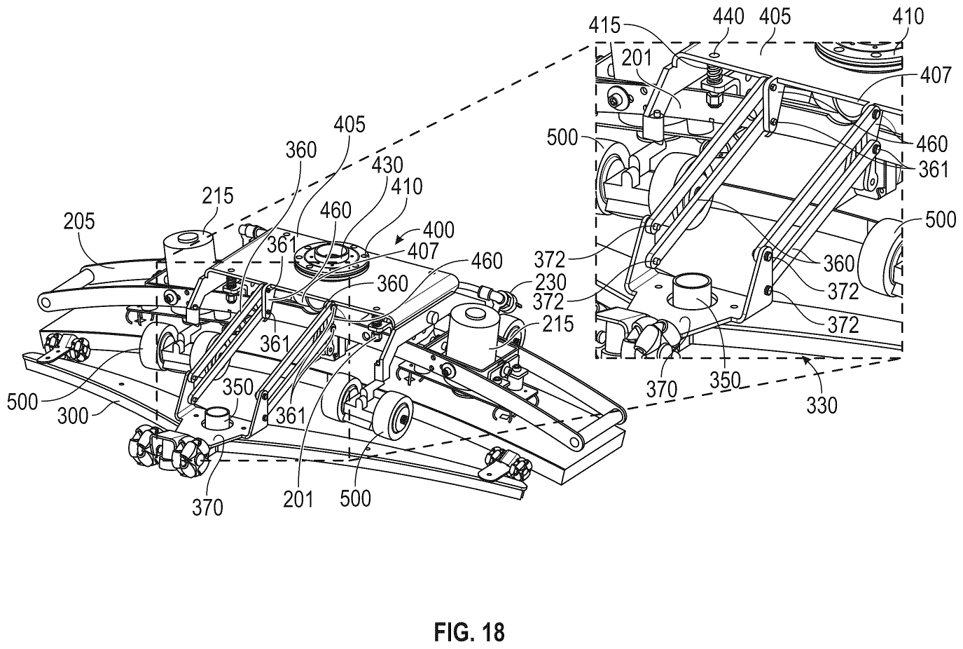

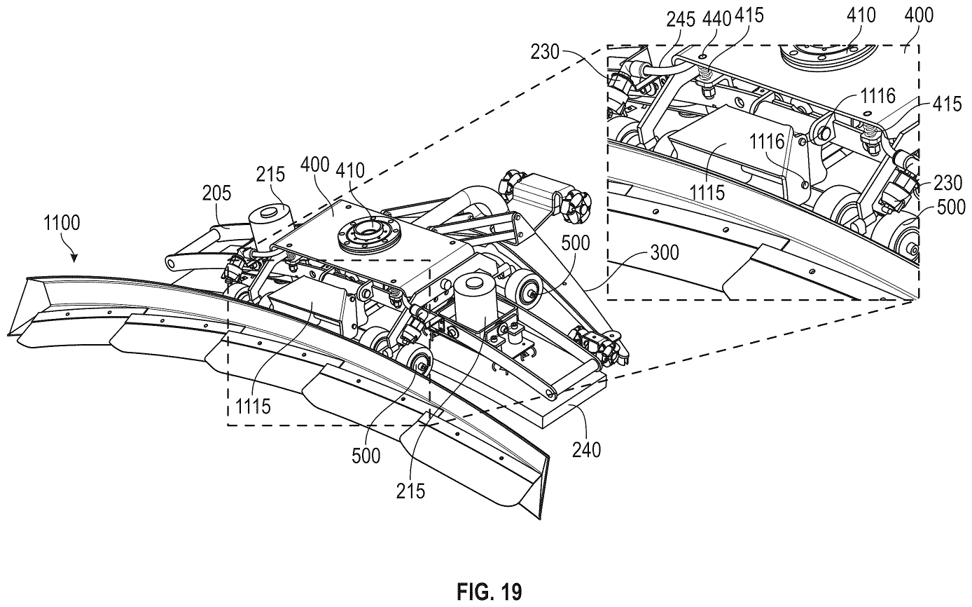

In an alternate embodiment, shown in FIGS. 6D, 6E, 6F, 18, and 19, a trailing bracket 370 couples a 4-bar linkage system 360 to the bracket 205 of the scrubber assembly 200. The 4-bar linkage system 360 provides freedom of movement to allow the wiper assembly 300 to move in the horizontal plane while maintaining a stationary level in the vertical plane. In this embodiment, shown in FIG. 18, the rotating platform 405 includes two 4-bar linkage system mounts 460 that are located at the rotating platform second end 407. In this preferred embodiment, there are the 4-bar linkage system mounts 460 instead of the wiper assembly connection point 445 (as in FIGS. 7A, 7B, and 7C) as in the previous embodiment. These mounts 460 are at the bracket top side 201, and preferably, the 4-bar linkage system mounts 460 include holes for two fasteners 361 each. The fasteners 361 are preferably pin or shoulder bolts that allow rotation. Further, the trailing bracket 370, shown in FIGS. 6D, 6E, and 6F, also includes two mount sides 371. These mount sides 371 also each include holes for two fasteners 372 each. These fasteners 372 are also pin or shoulder bolts to allow freedom of movement.

Additionally, as shown in FIGS. 6A-6F, in the preferred embodiment, the wiper assembly 300 includes at least one guide wheel assembly 315. The guide wheel assembly 315 is coupled to the flexible support back side 307 and aids in the wiper assembly 300 maintaining contact with the tower surface 1015. The guide wheel assembly 315 includes at least one non-magnetic guide wheel 316 and at least one magnet 320. This guide wheel assembly 315 works similarly to the wheel assembly 500. The magnet 320 is coupled to a stand-off spacer 321 and provides a force to maintain contact between the wiper assembly 300 and the tower surface 1015. The non-magnetic guide wheel 316 provides an air gap between the tower surface 1015 and the magnet 320 while the guide wheel 316 maintains contact with the tower surface 1015. This is crucial because the wiper element 310 can only properly function if it is in contact with the tower surface 1015. The non-magnetic guide wheel 316 is configured such that the wiper element 310 is able to deflect a specific amount so that the wiper element 310 conforms to the tower surface 1015 and properly cleans, but not over deflect so that the wiper element 310 becomes ineffective. It is preferred that the wiper element 310 deflects 30-45 degrees (30°-45°) to provide a cutting edge that properly cleans the tower surface 1015.

It is preferred that the guide wheel assembly 315 is configured such that there are two guide wheels 316 coupled to a guide wheel assembly bracket 318 with a magnet 320 coupled to the guide wheel assembly bracket 318 between the guide wheels 316. In the most preferred embodiment, the stand-off spacer 321 couples the magnet 320 to the guide wheel assembly bracket 318.

Preferably, the wiper assembly 300 comprises two guide wheel assemblies 315. As seen in FIGS. 6A-6F, the preferred configuration is for one guide wheel assembly 315 to be located at the flexible support first end 311 and the second guide wheel assembly 315 to be located at the flexible support second end 312. Moreover, in the most preferred embodiment, the non-magnetic guide wheel 316 is an omni-directional (omni-wheel) wheel or caster-type wheel that can move in multiple directions. This is preferred when the rotating platform assembly 400 rotates around the bearing 410 (see FIGS. 7A-7C). Because the wiper assembly 300 is coupled to the rotating platform assembly 400 and moves with it, the non-magnetic guide wheel 316 must move in multiple directions so that it does not skid on the tower surface 1015.

Finally, it is preferred that the wiper assembly 300 includes a wiper trailing wheel assembly 330. This wiper trailing wheel assembly 330 is coupled to the structural attachment bracket back end 327, as seen in FIGS. 6A, 6B, and 6C, or to the trailing bracket 370 as seen in FIGS. 6D, 6E, or 6F depending on the embodiment. The wiper trailing wheel assembly 330 is similar in configuration to the guide wheel assembly 315. It includes two non-magnetic wheels 331 and a magnet 332 (shown in FIGS. 8A, 8B, and 8C) and provides additional force to maintain contact between the wiper assembly 300 and the tower surface 1015. As above, it is preferred that the two non-magnetic wheels 331 are omni-wheels or casters. Moreover, in the most preferred embodiment, the magnet 332 is coupled to the trailing wheel assembly 330 via a standoff (not shown), but similar to the wheel assemblies 500.

In an alternate embodiment, the wiper assembly 300, as seen in FIGS. 8D, 8E, and 8F includes multiple guide wheel assemblies 315 that couple to the wiper assembly flexible support back side 307. These guide wheel assemblies 315 are similar to those described above with respect to FIGS. 8A, 8B, and 8C. The guide wheel assemblies 317 in this alternate embodiment, however, include two pair of guide wheels 316 and two magnets 320 on the guide wheel assemblies 315. This configuration allows the wiper assembly 300 to better connect with the tower surface 1015 during operation and prevents the wiper assembly 300 from detaching from the tower surface 1015 as it collects the dirty water.

In this alternate configuration, the wiper trailing wheel assembly 330 is closer to the scrubber assembly 200 so as to tow the wiper assembly up the tower surface 1015 rather than pushing it up. Additionally, in the alternate embodiment, the wiper trailing wheel assembly 330 includes two pair of non-magnetic wheels 331 and two magnets 332.

In a further alternate embodiment shown in FIGS. 8E and 8F, the flexible support 305 and wiper element 310 are configured such that the angled mid point 314 is oriented toward the scrubber assembly 200. This orientation allows the flexible support 305 and wiper element 310 the ability to maintain contact with the tower surface 1015. This orientation is preferred over the orientation shown in FIGS. 8A, 8B, 8C, and 8D where the angled mid point 314 is oriented toward the lower stabilizing wheel 720. When in operation, the configuration of the angled mid point 314, along with the additional guide wheel assemblies 315, provides a more efficient cleaning apparatus 100 that remains in constant contact with the tower surface 1015.

Moreover, as seen in the embodiment shown in FIGS. 8E and 8F, there is no vacuum adapter port 350 located near the mid point 314 of the flexible support 305 as seen in the embodiment of FIGS. 8A, 8B, 8C, and 8D. Because of the configuration of the embodiment shown in FIGS. 8E and 8F, the dirty water that is collected from the tower surface 1015 naturally tracks towards the first side 311 and second side 312 of the flexible support 305. Therefore, there are two vacuum adapter ports 350 that are each located at the first side 311 and second side 312, respectively, of the flexible support 305. These vacuum adapter ports 350 couple to a split vacuum hose 351 that in turn couples to the lower vacuum hose 825. Preferably, this coupling is done through a y-fitting, t-fitting, or any other type of compatible connection fitting.

In the preferred embodiment, the wiper assembly 300 is not constantly engaged with the tower surface 1015. It is preferred that the wiper assembly 300 only engages with the tower surface 1015 when the cleaning apparatus 100 is in the active cleaning mode. If the wiper assembly 300 is engaged with the tower surface 1015 when the cleaning apparatus 100 is not in the active cleaning mode, the wiper element 310 may experience chatter along the tower surface 1015 due to it being dry and can result in damage or premature degradation of the wiper element 310 and leave unwanted markings on the tower surface 1015.

Further, as shown in FIGS. 10A, 10B, 13, and 14, the preferred embodiment of the automated cleaning apparatus 100 includes a tank assembly 700 to carry water, cleaning fluid, and the collected dirty water solution, and a vacuum assembly 800 to capture the dirty water from the tower surface 1015 and reclaim it back in the tank assembly 700. The tank assembly 700 comprises a tank 705 and a fluid pump 710. The vacuum assembly 800 comprises a rotating vacuum adapter 805, a vacuum motor 810, a vacuum plenum 815, an upper vacuum hose 820, and a lower vacuum hose 825. It is preferable to include the vacuum plenum 815 because it prevents the vacuum motor 810 from inadvertently collecting fluid from the tank and dispersing it through the motor's exhaust port.

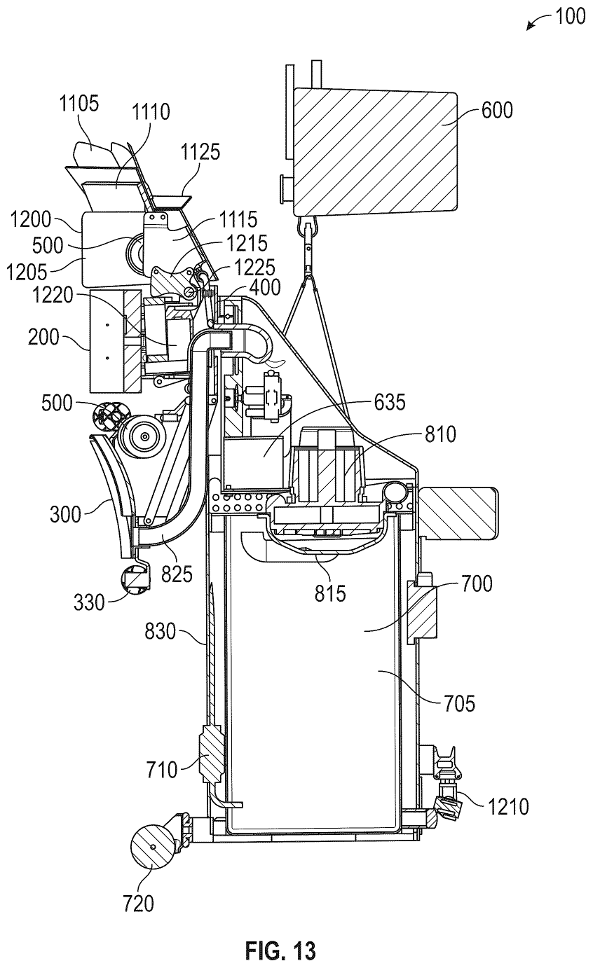

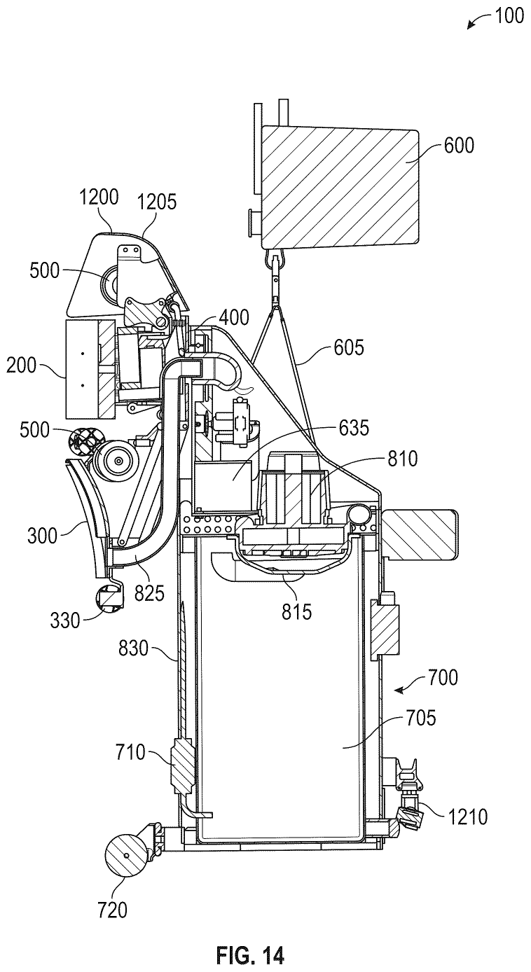

It is preferred that the fluid pump 710 couples to the fluid distribution tubing 245 and pumps the cleaning fluid through the fluid distribution tubing 245 and out the fluid dispensing device 230 of the scrubber assembly 200. The fluid pump 710 can be either submersible or in-line. The vacuum motor 810 is on the tank top side 706 and couples to the vacuum plenum 815. The upper vacuum hose 820 couples to the rotating vacuum adapter 805. Preferably, the rotating vacuum adapter 805 is concentric with the bearing 410 (shown in FIGS. 7A, 7B, and 7C) of the rotating platform 405 and connects the upper vacuum hose 820 to the lower vacuum hose 825. In the preferred embodiment, the lower vacuum hose 825 couples to the vacuum adapter port 350 on the wiper assembly flexible support back side 307 (shown in FIGS. 1A, 1B, and 6A-6F). It is preferred that vacuum motor 810, vacuum plenum 815, and upper vacuum hose 820 are housed under a cover 610 (shown in FIGS. 1A and 1B) to prevent dirt and debris from getting in the vacuum assembly 800 (shown in FIG. 10A) and tank assembly 700 (shown in FIGS. 13 and 14).

In the preferred embodiment, the cleaning apparatus 100 comprises one tank 705, but in an alternate embodiment, it can include a plurality of tanks. It is preferred that if the cleaning apparatus 100 includes a plurality of tanks, that there are two tanks, and that they are concentric or stacked vertically. As seen in FIGS. 1A, 1B, 13, and 14, the tank assembly 700 is preferably attached to the rotating platform assembly 400 via the frame assembly 830 and is the part of the cleaning apparatus 100 furthest away from the tower support structure 1000. It is preferred that the tank assembly 700 is located a certain distance from the tower support structure 1000 such that the center of gravity of the tank assembly 700 works with the other modular pieces of the cleaning apparatus 100 to ensure that the attachment to the tower surface 1015 is not compromised and the forces exerted by each modular piece work together as seen in FIG. 11. Because the tank assembly 700 includes fluid, the center of gravity becomes important to ensure the proper attachment of the cleaning apparatus 100 to the tower support structure 1000 and proper vertical movement during operation.

In the preferred embodiment with one tank 830, shown in FIG. 10A, the tank 830 includes a fluid filter 715 that removes dirt and debris from the dirty water solution collected through the rotating vacuum adapter 805, the upper vacuum hose 820, and the lower vacuum hose 825 to be recycled and used again in the cleaning apparatus 100 as clean water solution. In a more preferred embodiment, the cleaning apparatus 100 includes a removable filter assembly 900 and system as shown in FIGS. 1B, 2B, 2D, and 2E.

In the preferred embodiment, as seen in FIG. 2E, the removable filter assembly 900 includes an upper hose 905, a lower housing 910, a clamp 915, a filter cage 920, a removable bag filter 925, and a rubber pipe seal 930. These elements, when configured together, create the removable filter assembly 900 and system that is, preferably, located on the outside of the structural frame assembly 830 for easy maintenance access.

In the embodiment where the removable filter assembly 900 is used on the cleaning apparatus 100, shown in FIG. 1B the upper hose 905 couples to the rotating vacuum adapter 805 (shown in FIGS. 6A-6F) and connects the upper hose 905 to the lower vacuum hose 825. The dirty water collected from the wiper assembly 300 is put through the lower vacuum hose 825 as described above and moves through the rotating vacuum adapter 805 into the upper hose 905 of the filter assembly 900 (shown in FIG. 2E). The upper hose 905 moves the collected dirty water into the removable filter bag 925. It is preferred that the removable filter bag 925 is permeable to let the water pass through the filter bag 925 while retaining the debris, oil, and dirt. As seen in the exploded view in FIG. 2E, the filter bag 925 is housed in the filter cage 920 that is preferably a screen to allow the filtered water to pass through. The filter cage 920, in turn, fits in the lower housing 910. It is preferred that the lower housing 910 is coupled to the upper hose 905 via a clamp 915, however, this coupling can be through any suitable fastener. It is preferred that the lower housing 910 includes a filter assembly output fitting 911 that fits into the tank 705 (shown in FIGS. 2D, 13, and 14) and passes the clean water into the tank for use again as cleaning solution to be pumped through the fluid distribution tubing 245 and out through the fluid dispensing devices 230 (shown in FIG. 2D). The preferred embodiment provides that filter assembly output fitting 911 is surrounded by a rubber pipe seal 930 to ensure that there is no leakage between the removable filter assembly 900 and the tank 705.

For ease of use and maintenance, it is preferred that the removable filter assembly 900 is located on the outside of the tank assembly 700 and structural frame assembly 830. This configuration allows the operator to easily remove the filter assembly 900 without removing the entire cover 610 of the cleaning apparatus 100 as it makes its way to the bottom of the tower support structure 1000. The operator unfastens the clamp 915, removes the filter cage 920, empties the removable bag filter 925, and replaces the components to allow the cleaning apparatus 100 to continue its cleaning up and down the tower support structure 1000. Additionally, if the tank 705 is running low on water/cleaning solution, more can be added through the removable filter assembly 900. In the most preferred embodiment, the removable filter assembly 900 and system provide a way for the cleaning apparatus 100 to be fully self-contained and environmentally friendly.

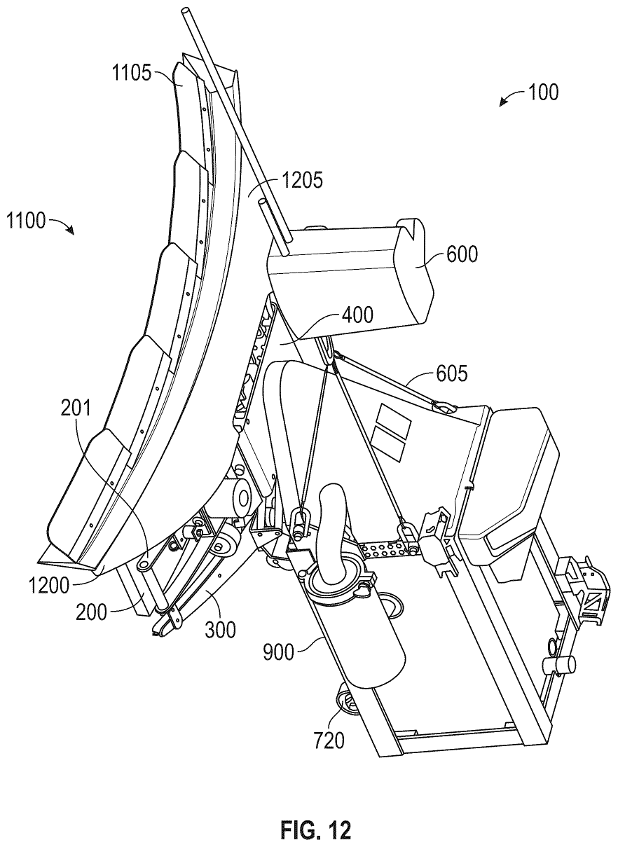

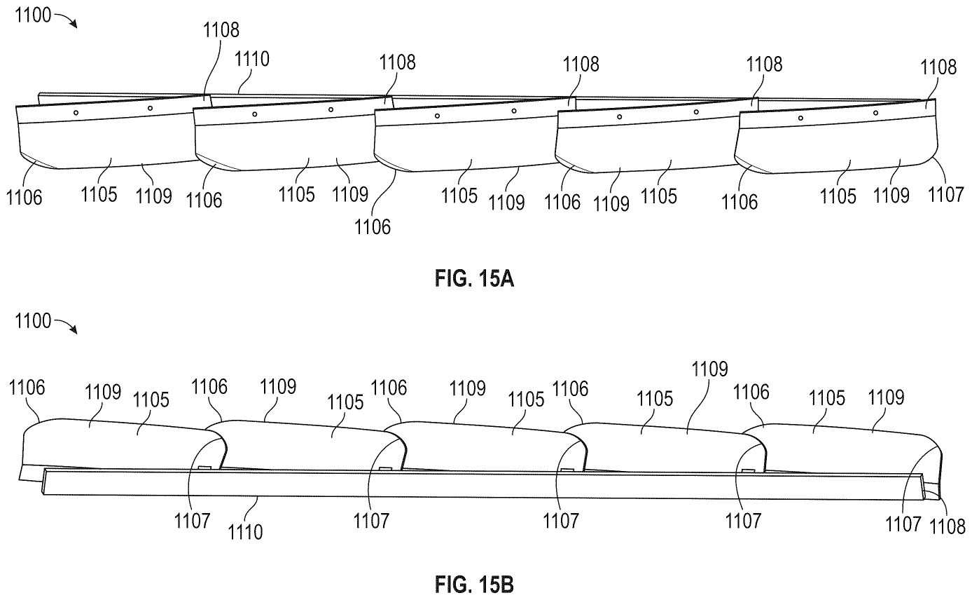

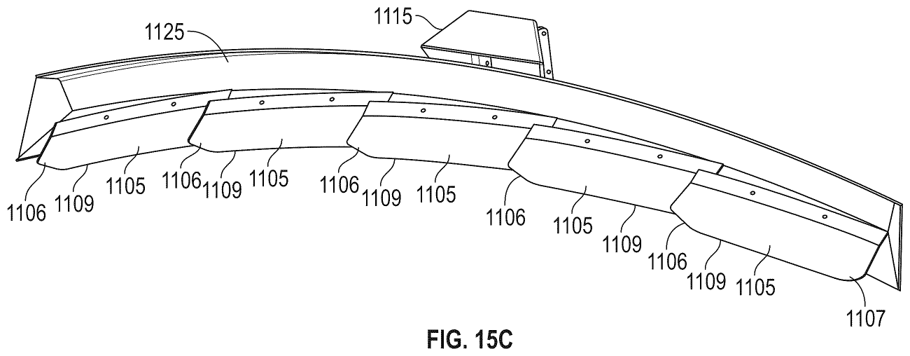

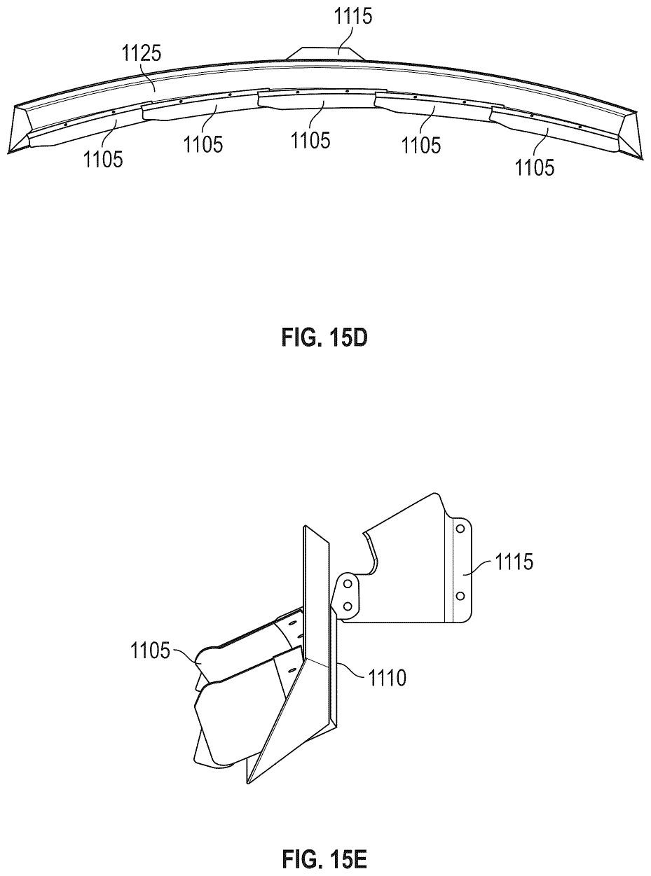

In an alternate embodiment, as shown in FIGS. 12, 13, and 19, the cleaning apparatus 100 includes a scraper assembly 1100. The scraper assembly 1100 is coupled to the bracket top side 201. It is preferred that this coupling is via a removable bolt, pin, or any acceptable attachment that functions in a similar way. In this embodiment, the scraper assembly 1100 includes a scraper element 1105, a frame 1110, a mounting bracket 1115, and a gutter 1125. As seen in FIGS. 15A, 15B, 15C, 15D, and 15E, the preferred embodiment includes multiple scraper elements 1105 that are coupled to the frame 1110. However, there could be one scraper element 1105 in an alternate embodiment. It is preferred that the frame 1110 is made of a semi-flexible material so that the scraper elements 1105 can articulate on the tower surface 1015 while the cleaning apparatus 100 is moving up and down the tower 1000.

The scraper elements 1105 (shown in FIGS. 15A-15D) remove larger amounts of dirt and grease that the scrubber pads 240 cannot remove on their own. It is preferred that the scraper elements 1105 are also made of a semi-flexible material so that as they move over the tower surface 1015, they have some freedom of movement and do not damage the tower surface 1015 while still effectively dislodging grease. It is preferred that this semi-flexible material is a flexible polymer or metal. Preferably, each scraper element 1105 couples to the frame 1110 in an overlapping and angled configuration as shown in FIGS. 15A-15D. This configuration allows the scraper assembly 1100 to cover the entire surface area in its path as it moves along the tower surface 1015.

It is preferred that the shape of the scraper elements 1105 is such that the leading corner 1106 of the scraper element 1105 curves upward to go over uneven terrain of the tower surface 1015 and handle changes in gradient much like the tip of a ski as shown in FIGS. 15A and 15B. This shape allows the scraper element 1105 to travel over the weld seams or other abnormalities on the tower surface 1015 without grabbing or becoming stuck. Additionally, it is preferred that the rear angle 1108 of the scraper elements 1105 is such that the leading corner 1106 is in a position to travel over the weld seams. Finally, it is preferred that the leading corner 1106 and the rear corner 1107 are both rounded to prevent from catching on the weld seams on the tower surface 1015. While this is the preferred embodiment and allows the scraper elements 1105 to bend over the weld seams and keep the scraper edge 1109 in contact with the tower surface 1015 while preventing damage, any shape and angle that effectuates the scraper element 1105 to easily move over the weld seams is acceptable.

The scraper assembly 1100 also includes a rigid mounting bracket 1115, as seen in FIGS. 13, 15C, 15D, 15E, and 19. This rigid mounting bracket 1115 couples the frame 1110 to the scrubber assembly bracket 205 or to the spray shroud assembly 1200 (shown in FIGS. 12 and 13). It is preferred that these attachments are made via pins or bolts that allow rotation. In the preferred embodiment, this mounting bracket 1115 can pivot to move the scraper assembly 1100 on and off the tower. The scraper assembly 1100 is only needed to engage the tower when large amounts of dirt and/or grease are detected. In the preferred embodiment, a removable camera assembly 1210 (shown in FIGS. 13 and 14) that attaches to the structural frame assembly 830 (shown in FIGS. 1A and 1B) can aid in the detection of the grease as the cleaning apparatus 100 moves along the tower surface 1015.

In a more preferred embodiment, the scraper assembly 1100 also includes a gutter 1125 as shown in FIGS. 15C and 15D. The gutter 1125 is attached to the frame 1110 and collects the grease and debris that is scraped off of the tower surface 1015. The grease and debris are cleaned out of the gutter 1125 at some frequency. This configuration keeps the grease from falling to the ground and contaminating what it contacts.

Preferably, the scraper assembly 1100 is coupled to the spray shroud assembly 1200 as seen in FIGS. 12 and 13. The spray shroud assembly 1200 includes a shroud 1205, a pivoting link 1215, a linear actuator 1220, and a pivot pin 1225. The shroud 1205 is in a general shape to cover the fluid dispensing devices 230 (shown in FIG. 4) on the scrubber assembly 200. This helps protect the cleaning solution spray from the fluid dispensing devices 230 onto the tower surface 1015 from blow away and evaporation caused by environmental conditions. Because the cleaning apparatus 100 generally operates in windy conditions, it is important to control as much spray waste and evaporation as possible. Additionally, the shroud 1205 aids in reducing the cleaning solution escaping onto the ground and any plants or animals below the tower support structure 1000 making it truly self-contained and environmentally friendly. Moreover, the shroud 1205 can articulate as it moves along the tower surface 1015 to accommodate the conical shape of the tower support structure 1000.

In the preferred embodiment, as seen in FIGS. 12 and 13 the shroud assembly 1200 is attached to the scrubber assembly 200 via the pivoting link 1215 and pivot pin 1225. This allows the shroud assembly 1200 and the attached scraper assembly 1100 to move on and off the tower surface 1015. It is preferred that a linear actuator 1220 powers this mechanism, but any other power source can be used to affect this movement. It is preferred that the shroud assembly 1200 be moved off the tower support structure 1000 as it approaches the nacelle part of the tower support structure 1000 to clean as close to the top of the tower support structure 1000 as possible. As stated earlier, the preferred camera assembly 1210 aids the user in determining when to move the shroud assembly 1200 on and off of the tower support structure 1000.

As seen from the above description of the preferred embodiments of the cleaning apparatus 100, the rotating platform assembly 400, the wheel assembly 500, the scrubber assembly 200, the wiper assembly 300, the tank assembly 700, the vacuum assembly 800, the removable filter assembly 900, the scraper assembly 1100, and the shroud assembly 1200 are all modular in nature. Each assembly fits together in such a way as to be easily transported, assembled, maintained and/or modified based on the specific job conditions. Every turbine tower 1050 cleaning situation is unique based on the location, external conditions, and the amount of dirt that is on the tower support structures 1000. The modular design of the cleaning apparatus 100 makes the device versatile to conform to all of these conditions.

Each assembly piece can easily be removed from the cleaning apparatus 100, as a whole, allowing it to be deconstructed and each assembly placed in a standard transport that transports it to a job site. It is preferred that the transport is a standard trailer, but it can be any type of transfer, such as a van, pickup truck, semitrailer, boat, offshore vessel, etc. As the number of turbine towers 1050 to be cleaned at a particular job site can be numerous, each turbine tower 1050 may have unique cleaning needs. Once the transport arrives at the job site, a technician can construct the separate assemblies with standard tools in a short time. At this time, the technician can determine whether the inside or the outside of the tower support structure 1000 is going to be cleaned to determine whether a convex or concave scrubber assembly 200 will be installed, the weather conditions to determine whether a shroud assembly 1220 will be necessary, and/or whether there is grease on the tower surface 1015 to determine whether the scraper assembly 1100 is needed. Once the cleaning apparatus 100 is fully assembled according to the conditions, one technician will climb the tower support structure 1000 to properly install the rope rigging system to the nacelle, and the other technician will stay on the ground and ready the cleaning apparatus 100 to begin cleaning the tower support structure 1000. When the cleaning apparatus 100 is rigged in place and ready to begin working, the technician remotely operates the cleaning apparatus 100 that receives its instructions via the radio control module 620 (shown in FIG. 1A) preferably located on the structural frame assembly 830 or tank assembly 700.

As the cleaning apparatus 100 is on the tower support structure 1000 and in its working mode to clean the tower surface 1015, it is preferred that the technician monitors the onboard camera assemblies 1210 (shown in FIGS. 13 and 14) to determine changes that may need to be made. As the cleaning apparatus 100 makes its path to the bottom of the tower support structure 1000, the technician can visually inspect it for any problems. If there is a problem, the modular nature of the cleaning apparatus 100 allows for it to be easily addressed in the field. Spare parts, or even spare modules, can be in the transport for quick maintenance of the cleaning apparatus 100 while at the site. Moreover, because the cleaning apparatus 100 does not require large amounts of water through its self-containment and recycling features, if the tank 705 does run low on water, it can be replaced with small amounts of water transported to the site. The cleaning apparatus 100 is an efficient, safe, cost-effective way to clean substantially vertical surfaces, such as turbine towers 1050.

What is claimed is:

1. A cleaning apparatus for use on a substantially vertical surface comprising:
a rotating platform assembly comprising:
a rotating platform comprising a rotating platform first end and a rotating platform second end and a rotating platform first side and a rotating platform second side and a rotating platform center;
a bearing having a bearing center coupled to the rotating platform such that the bearing center aligns with the rotating platform center and wherein the bearing allows the rotating platform to rotate;
a first rocker arm and a second rocker arm, each having a first wheel assembly connection point and a second wheel assembly connection point, respectively;
wherein the first rocker arm is moveably coupled to the rotating platform first side and the second rocker arm is moveably coupled to the rotating platform second side;
a plurality of wheel assemblies, each wheel assembly comprising:
an articulating wheel base having an apparatus side and a surface side and an articulating wheel base first side and an articulating wheel base second side;
a plurality of non-magnetic wheels wherein the plurality of wheels are coupled to the articulating wheel base first side and the articulating wheel base second side;
at least one magnet wherein the at least one magnet couples to the articulating wheel base movably coupling the cleaning apparatus to the substantially vertical surface;
a scrubber assembly comprising:
a scrubber backing plate having a scrubber backing plate front side and a scrubber backing plate back side;
a bracket with at least one mounting tab wherein the bracket is removably coupled to the scrubber backing plate back side and includes a bracket top side and a bracket bottom side and a bracket scrubber backing plate side and a bracket rotating platform side;
fluid distribution tubing comprising at least one fluid dispensing device and coupled to the bracket;
at least one scrubber pad removably coupled to the scrubber backing plate front side;
a motor assembly wherein the motor assembly comprises a motor, a shaft, and an eccentric plate mount, wherein the shaft is coupled to the eccentric plate mount;
wherein the motor assembly is coupled to a motor face plate and the motor face plate comprises a hole wherein the shaft extends in the direction of the scrubber backing plate through the hole;
wherein the eccentric plate mount contacts the scrubber backing plate backside; and
wherein the motor face plate is coupled to the scrubber backing plate with at least one vibration isolator;
a wiper assembly comprising:
at least one wiper element; and
a tank assembly comprising:
at least one tank coupled to the fluid distribution tubing.

2. The cleaning apparatus of claim 1 wherein the wheel assembly magnets create a magnetic circuit.

3. The cleaning apparatus of claim 1 wherein the wheel assembly further comprises rub protection blocks wherein the rub protection blocks are coupled to the magnets.

4. The cleaning apparatus of claim 1 wherein the at least one magnet couples to the articulating wheel base surface side between each wheel.

5. The cleaning apparatus of claim 1 wherein the magnets are angled.

6. The cleaning apparatus of claim 1 wherein each of the second connection points of the rockers arms is a two-axis wheel adapter.

7. The cleaning apparatus of claim 1 wherein the scrubber backing plate comprises a plurality of scrubber backing plates that are not directly coupled and wherein the scrubber pad comprises a plurality of pad parts that are not directly coupled.

8. The cleaning apparatus of claim 1 wherein the scrubber assembly further comprises at least one scrubber preload spring coupled to the mounting tabs and to the rotating platform.

9. The cleaning apparatus of claim 1 wherein the motor assembly is coupled to a motor gimbal, and wherein the motor gimbal is coupled to the bracket and the motor face plate.

10. The cleaning apparatus of claim 1 wherein the scrubber assembly fits within a distance between the wheel assemblies of each of the first and second rocker arms.

11. The cleaning apparatus of claim 1 wherein the wiper element is selected from the group consisting of:
a nozzle;
a spray bar;
a perforated jet line; and
combinations thereof.

12. The cleaning apparatus of claim 1 wherein the wiper assembly further comprises:
a flexible support having a flexible support front side and a flexible support backside and a flexible support top side and a flexible support bottom side;
the at least one wiper element coupled to the flexible support front side;
a structural attachment bracket comprising a structural attachment bracket front end and a structural attachment back end wherein the structural attachment front end is movably coupled to the rotating platform;
at least one guide wheel assembly coupled to the flexible support back side and further comprising at least one non-magnetic wheel and at least one magnet; and
a wiper trailing assembly coupled to the structural attachment bracket back end.

13. The cleaning apparatus of claim 11 wherein the wiper element is selected from the group consisting of:
a leading wiper;
a trailing wiper;
a trailing wiper with leading intermittent wipers;
a leading and a trailing wiper; and
combinations thereof.

14. The cleaning apparatus of claim 11 wherein the wiper assembly further comprises at least two guide wheel assemblies wherein one guide wheel assembly is coupled to a flexible support first end and one guide wheel assembly is coupled to a flexible support second end.

15. The cleaning apparatus of claim 1 wherein the tank assembly further comprises:
a vacuum motor wherein the vacuum motor is on a tank top side and couples to a vacuum plenum;
a fluid pump wherein the fluid pump is coupled to the fluid distribution tubing;
an upper vacuum hose wherein the upper vacuum hose couples to a rotating vacuum adapter wherein the rotating vacuum adapter is concentric with the at least one bearing of the rotating platform and couples the upper vacuum hose to a lower vacuum hose; and
wherein the lower vacuum hose is coupled to a vacuum adapter port on the wiper assembly flexible support back side.

16. The cleaning apparatus of claim 14 wherein the tank assembly further comprises a removable filter assembly.

17. The cleaning apparatus of claim 1 further comprising a scraper assembly.

18. The cleaning apparatus of claim 1 further comprising a shroud assembly.

19. A cleaning apparatus for use on a vertical surface comprising:
a platform assembly comprising:
a platform comprising a platform first end and a platform second end and a platform first side and a platform second side and a platform center;
a first rocker arm and a second rocker arm each having a first wheel assembly connection point and a second wheel assembly connection point, respectively;
wherein the first rocker arm is moveably coupled to the rotating platform first side and the second rocker arm is moveably coupled to the rotating platform second side;
a plurality of wheel assemblies, each wheel assembly comprising:
an articulating wheel base having an apparatus side and a surface side and an articulating wheel base first side and an articulating wheel base second side;
a plurality of non-magnetic wheels wherein the plurality of wheels are coupled to the articulating wheel base first side and the articulating wheel base second side;
at least one magnet wherein the at least one magnet couples to the articulating wheel base allowing the cleaning apparatus to be used on the substantially vertical surface;
a scrubber assembly comprising:
a scrubber backing plate having a scrubber backing plate front side and a scrubber backing plate back side;
a bracket with at least one mounting tab wherein the bracket is removably coupled to the scrubber backing plate back side and includes a bracket top side and a bracket bottom side and a bracket scrubber backing plate side and a bracket platform side;
fluid distribution tubing comprising at least one fluid dispensing device and coupled to the bracket;
at least one scrubber pad removably coupled to the scrubber backing plate front side;
a motor assembly wherein the motor assembly comprises a motor, a shaft, and an eccentric plate mount, wherein the shaft is coupled to the eccentric plate mount;
wherein the motor is coupled to a motor face plate and the motor face plate comprises a hole wherein the shaft extends in the direction of the scrubber backing plate through the hole;
wherein the eccentric plate mount contacts the scrubber backing plate backside; and
wherein the motor face plate is coupled to the scrubber backing plate with at least one vibration isolator,
a wiper assembly comprising:
at least one wiper element; and
a tank assembly comprising:
at least one tank coupled to the fluid distribution tubing.

20. The cleaning apparatus of claim 19 wherein the wheel assembly magnets create a magnetic circuit.

21. The cleaning apparatus of claim 19 wherein the wheel assembly further comprises rub protection blocks wherein the rub protection blocks are coupled to the magnets.

22. The cleaning apparatus of claim 19 wherein the at least one magnet couples to the articulating wheel base surface side between each wheel.

23. The cleaning apparatus of claim 19 wherein the magnets are angled.

24. The cleaning apparatus of claim 19 wherein the scrubber backing plate comprises a plurality of scrubber backing plate parts that are not directly coupled, and wherein the scrubber pad comprises a plurality of pad parts that are not directly coupled.

25. The cleaning apparatus of claim 19 wherein the scrubber assembly further comprises at least one scrubber preload spring coupled to the mounting tabs and to the platform.

26. The cleaning apparatus of claim 19 wherein the motor assembly is coupled to a motor gimbal, and wherein the motor gimbal is coupled to the bracket and the motor face plate.

27. The cleaning apparatus of claim 19 wherein the scrubber assembly fits within a distance between the wheel assemblies of each of the first and second rocker arms.

28. The cleaning apparatus of claim 19 wherein the wiper element is selected from the group consisting of:
a nozzle;
a spray bar;
a perforated jet line; and
combinations thereof.

29. The cleaning apparatus of claim 19 wherein the wiper assembly further comprises:
a flexible support having a flexible support front side and a flexible support backside and a flexible support top side and a flexible support bottom side;
the at least one wiper element coupled to the flexible support front side;
a structural attachment bracket comprising a structural attachment bracket front end and a structural attachment back end wherein the structural attachment front end is movably coupled to the rotating platform;
at least one guide wheel assembly coupled to the flexible support back side and further comprising at least one non-magnetic wheel and at least one magnet; and
a wiper trailing assembly coupled to the structural attachment bracket back end.

30. The cleaning apparatus of claim 29 wherein the flexible wiper is selected from the group consisting of:
a leading wiper;
a trailing wiper;
a trailing wiper with leading intermittent wipers;
a leading and a trailing wiper; and
combinations thereof.

31. The cleaning apparatus of claim 29 wherein the wiper assembly further comprises a pair of guide wheel assemblies wherein one guide wheel assembly is coupled to a flexible support first end and one guide wheel assembly is coupled to a flexible support second end.

32. The cleaning apparatus of claim 19 wherein the tank assembly further comprises:
a vacuum motor wherein the vacuum motor is on a tank top side and couples to a vacuum plenum;
a fluid pump wherein the fluid pump is coupled to the fluid distribution tubing;
an upper vacuum hose wherein the upper vacuum hose couples to a rotating vacuum adapter wherein the rotating vacuum adapter is concentric with the at least one bearing of the rotating platform and couples the upper vacuum hose to a lower vacuum hose; and
wherein the lower vacuum hose is coupled to a vacuum adapter port on the wiper assembly flexible support back side.

33. The cleaning apparatus of claim 32 wherein the tank assembly further comprises a removable filter assembly.

34. The cleaning apparatus of claim 19 further comprising a scraper assembly.

35. The cleaning apparatus of claim 19 further comprising a shroud assembly.
